(19) United States
(12) Patent Application Publication
(10) Pub. No.: US 2024/0086912 A1
(43) Pub. Date: Mar. 14, 2024

(54) PLATFORM AND METHOD FOR ANALYZING TRANSACTIONS PERFORMED BY A PLURALITY OF BLOCKCHAIN NODES IMPLEMENTING A DECENTRALIZED EXCHANGE FUNCTIONALITY

(71) Applicant: FLUIDEFI INC, MONTREAL (CA)

(72) Inventors: Louis SIRICO, MONTREAL (CA); Justin JORDAN, KAMLOOPS (CA); Abdennour AISSAOUI, TORONTO (CA)

(73) Assignee: FLUIDEFI INC, MONTREAL, QC (CA)

(21) Appl. No.: 18/459,178

(22) Filed: Aug. 31, 2023

Related U.S. Application Data
(60) Provisional application No. 63/375,092, filed on Sep. 9, 2022.

(51) Int. Cl. G06Q 20/38

(52) U.S. Cl. CPC G06Q 20/389; G06Q 20/3825; G06Q 40/04

(57) ABSTRACT

Platform and method for collecting and analyzing transactions performed on digital token pools managed by a blockchain. The platform collects transaction data related to transactions performed on the digital token pools managed by the blockchain. The transaction data related to each transaction are collected from N geographically distributed nodes belonging to the blockchain, the transaction data being stored in data blocks at the N nodes. A validation algorithm is used to determine validated transaction data based on the collected transaction data, comprising comparing for each transaction the transaction data collected from the N nodes and determining the validated transaction data for the transaction based at least on a result of the comparison. The validated transaction data are processed to calculate a value of at least one metric based on the validated transaction data. The transaction data may be related to transactions performed on digital token pools managed by several blockchains.

### TECHNICAL FIELD

The present disclosure relates to the field of decentralized exchange functionalities provided by nodes of a blockchain. More specifically, the present disclosure relates to a platform and method for analyzing transactions performed by a plurality of blockchain nodes implementing a decentralized exchange functionality.

### BACKGROUND

The usage of cryptocurrencies and other types of digital tokens has been increasing steadily in the past several years. Tens of thousands of digital tokens (including cryptocurrencies) are publicly available on different blockchains with more being created every day. There are thousands of marketplaces for buying and trading digital tokens (e.g. cryptocurrencies). A first type of marketplace is a centralized one, where a centralized exchange server allows the buying and trading of digital tokens (including, but not limited to, cryptocurrencies). A centralized marketplace operates in a similar manner as centralized marketplaces for trading stocks, bonds, utilities, etc. One constraint with a centralized marketplace is that a transaction for trading requires a counterpart (a buyer needs one or more counterpart sellers and a seller needs one or more counterpart buyers).

A second type of marketplace is a decentralized one, where a decentralized exchange server allows the trading of various types of digital tokens (including, but not limited to, cryptocurrencies). Each transaction is recorded on a blockchain comprising a plurality of nodes implementing the decentralized marketplace. Each node, or validator, that is participating in the blockchain provides the functionalities of a decentralized exchange server.

The number of available blockchains and corresponding decentralized exchange servers is steadily increasing, making it more difficult for a client to select one among a plurality of candidate blockchains/corresponding decentralized exchange servers capable of performing a transaction initiated by a client on a particular type of digital token. It would be helpful for the client to have at his disposal a set of tools to identify decentralized exchanges, metrics evaluating various aspects of the operations of the candidate blockchains, corresponding decentralized exchange (DEX) servers, and the digital tokens that may be transacted using DEX servers. This set of metrics would allow the client to select among the candidate blockchains, DEX servers, etc., by determining, based on the metrics, which one of the candidate blockchains, DEX servers, etc., meets his needs and requirements.

Therefore, there is a need for a new platform and method for analyzing transactions performed by a plurality of blockchain nodes implementing a decentralized exchange functionality.

### SUMMARY

According to a first aspect, the present disclosure relates to a platform comprising a communication interface, memory and a processing unit (comprising one or more processors). The processing unit is configured to collect via the communication interface transaction data related to transactions performed on digital token pools managed by a blockchain. The transaction data related to each transaction are collected from N geographically distributed nodes belonging to the blockchain, N being an integer greater than one. The transaction data are included in data blocks stored at the N nodes. The processing unit is configured to apply a validation algorithm to determine validated transaction data based on the collected transaction data. The validation algorithm comprises comparing for each transaction the transaction data collected from the N nodes and determining the validated transaction data for the transaction based at least on a result of the comparison. The processing unit is configured to process the validated transaction data to calculate a value of at least one metric based on the validated transaction data. The processing unit is configured to store the calculated value of the at least one metric in the memory, or to transmit the calculated value of the at least one metric via the communication interface to at least one remote device for remote storage.

According to a second aspect, the present disclosure relates to a method for collecting and analyzing transactions performed on digital token pools managed by a blockchain. The method comprises collecting by a processing unit of a platform via a communication interface of the platform transaction data related to transactions performed on digital token pools managed by a blockchain. The transaction data related to each transaction are collected from N geographically distributed nodes belonging to the blockchain, N being an integer greater than one, the transaction data being included in data blocks stored at the N nodes. The method comprises applying by the processing unit of the platform a validation algorithm to determine validated transaction data based on the collected transaction data. The validation algorithm comprises comparing for each transaction the transaction data collected from the N nodes and determining the validated transaction data for the transaction based at least on a result of the comparison. The method comprises processing by the processing unit of the platform the validated transaction data to calculate a value of at least one metric based on the validated transaction data. The method comprises storing by the processing unit of the platform the calculated value of the at least one metric in a memory of the platform, or transmitting the calculated value of the at least one metric via the communication interface to at least one remote device for remote storage.

According to a third aspect, the present disclosure relates to a non-transitory computer-readable medium comprising instructions executable by a processing unit of a platform. The execution of the instructions by the processing unit of the platform provides for collecting and analyzing transactions performed on digital token pools managed by a blockchain, by implementing the aforementioned method.

In a particular aspect, the transaction data are related to transactions performed on digital token pools managed by a plurality of blockchains, the transaction data being collected for each blockchain from the N nodes belonging to the blockchain. In a particular embodiment, the plurality of blockchains comprises a layer 1 blockchain and a layer 2 blockchain, the transaction data collected from the layer 1 blockchain comprising at least one of a summary and a roll-up of transaction data recorded on the layer 2 blockchain.

In another particular aspect, the number N of nodes varies over time.

In still another particular aspect, at least one of the N nodes varies over time.

In yet another particular aspect, the transactions comprise at least one of the following: a swap transaction, a sync transaction, a mint transaction, a burn transaction, and a combination of unitary transactions.

In another particular aspect, at least some of the validated transaction data are stored in the memory before being processed.

In still another particular aspect, the processing unit is further configured to transmit to one or more client devices via the communication interface one or more values of at least one among the at least one metric.

In yet another particular aspect, an alert is configured for a given metric, the configuration comprising storing a threshold value and an identification of a client device. A value related to the given metric is determined. The value related to the given metric is compared with the threshold value. If the value of the given metric reaches the threshold value, the alert is triggered, the triggering of the alert comprising transmitting an alert message to the client device corresponding to the previously stored identification of the client device. In a particular embodiment, the alert is configured with a plurality of metrics and a corresponding plurality of thresholds, the alert being triggered if values associated to the plurality of metrics simultaneously reach their respective corresponding thresholds.

In another particular aspect, the processing unit is further configured to execute a machine learning engine. The machine learning engine uses a predictive model stored in the memory for inferring one or more outputs based on inputs, the one or more outputs comprising a predicted volume for a digital token pool, the inputs comprising the value of the at least one metric.

In still another particular aspect, the at least one metric comprises at least one of the following: a number of transactions over a time period, a number of digital tokens over a time period, a number of digital wallets managed over a time period, a number of participants to transactions over a time period.

### BRIEF DESCRIPTION OF THE DRAWINGS

Embodiments of the disclosure will be described by way of example only with reference to the accompanying drawings, in which:

FIG. 1 represents a centralized architecture based on a centralized exchange server for trading digital tokens, and recording some or all transactions to a blockchain, according to the prior art;

FIGS. 2A, 2B and 2C represent a decentralized architecture based on a decentralized exchange (DEX) functionality implemented by nodes of a blockchain for performing digital token transactions;

FIG. 3 represents the evolution of the number of digital tokens in a digital token pool managed by the DEX functionality illustrated in FIGS. 2A, 2B and 2C;

FIGS. 4A and 4B represent a platform adapted for collecting and analyzing data related to digital token transactions performed by a plurality of DEX functionalities operating on a plurality of nodes of a plurality of blockchains similar to the one illustrated in in FIGS. 2A, 2B and 2C;

FIG. 4C represents the platform illustrated in FIG. 4A being adapted to interact with layer 1 and layer 2 blockchains;

FIG. 5A represents a method implemented by the platform of FIGS. 4A-B for calculating the values of metrics based on the collected data related to the digital token transactions performed by the plurality of DEX functionalities operating on the plurality of nodes of the plurality of blockchains;

FIG. 5B represents a method implemented by the platform of FIGS. 4A-B for generating an alert related to a metric calculated by the method of FIG. 5A; and

FIGS. 6 and 7 represent predictions performed by a neural network with respect to metrics calculated via the method of FIG. 5A.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the collection, analysis and monitoring of digital token transactions performed by a plurality of decentralized exchange (DEX) functionalities operating on a plurality of nodes on a plurality of blockchains. The DEX functionalities are implemented by software program(s) executed by the nodes. The analysis includes generating metrics based on transaction data related to the digital tokens performed by the DEX functionalities operating on the nodes of the blockchains. The analysis also includes monitoring the operations of the DEX functionalities operating on the nodes of the blockchains, by setting alerts triggered by the occurrence of events (e.g. the value of a metric reaching a pre-defined threshold, a variation in the value of a metric over a period of time reaching a pre-defined threshold, etc.). The analysis further includes making predictions on the future value of some of the metrics (or the future value of other parameters related to the digital token transactions).

Throughout the present specification and claims, the following definitions are used:

Blockchain: a blockchain refers to the entire decentralized infrastructure providing chronological order, redundancy, reliability, and security for storing transactions. In the rest of the description, the terminology blockchain encompasses hardware components (e.g. computers, servers, etc.) implementing the blockchain, software components (e.g. software stored on and executed by the hardware components of the blockchain) implementing the blockchain, and data components (e.g. a chain of blocks of data stored on the hardware components of the blockchain) implementing the blockchain.

Digital token: a digital token is a digital asset managed via at least one blockchain. Any transaction involving a digital token is recorded on the blockchain(s). Examples of digital tokens include, but are not limited to: cryptocurrency tokens (e.g, Ethereum, Bitcoin, etc.), fiat currencies tokens (e.g. CAD digital tokens, USD digital tokens, Euro digital tokens, etc.), utility tokens (digital tokens that have some useful functionality), digital tokens backed by a precious metals (e.g. gold or silver etc.), tangible asset tokens (digital tokens backed by tangible assets, e.g. real estate tokens that are issued for a parcel of land or structure), lending tokens (digital tokens that are issued as returns to token holders), financial asset tokens (digital tokens backed by a financial assets, such as stocks, bonds, derivatives, etc.), etc.

Digital token pool: a digital token pool is a mechanism by which users can contribute their digital tokens to a pool managed by a DEX functionality (smart contracts) implemented by a blockchain, that allows other clients to swap or exchange those digital tokens. Digital token pools include, but are not limited to, a particular type of pools referred to as liquidity pools.

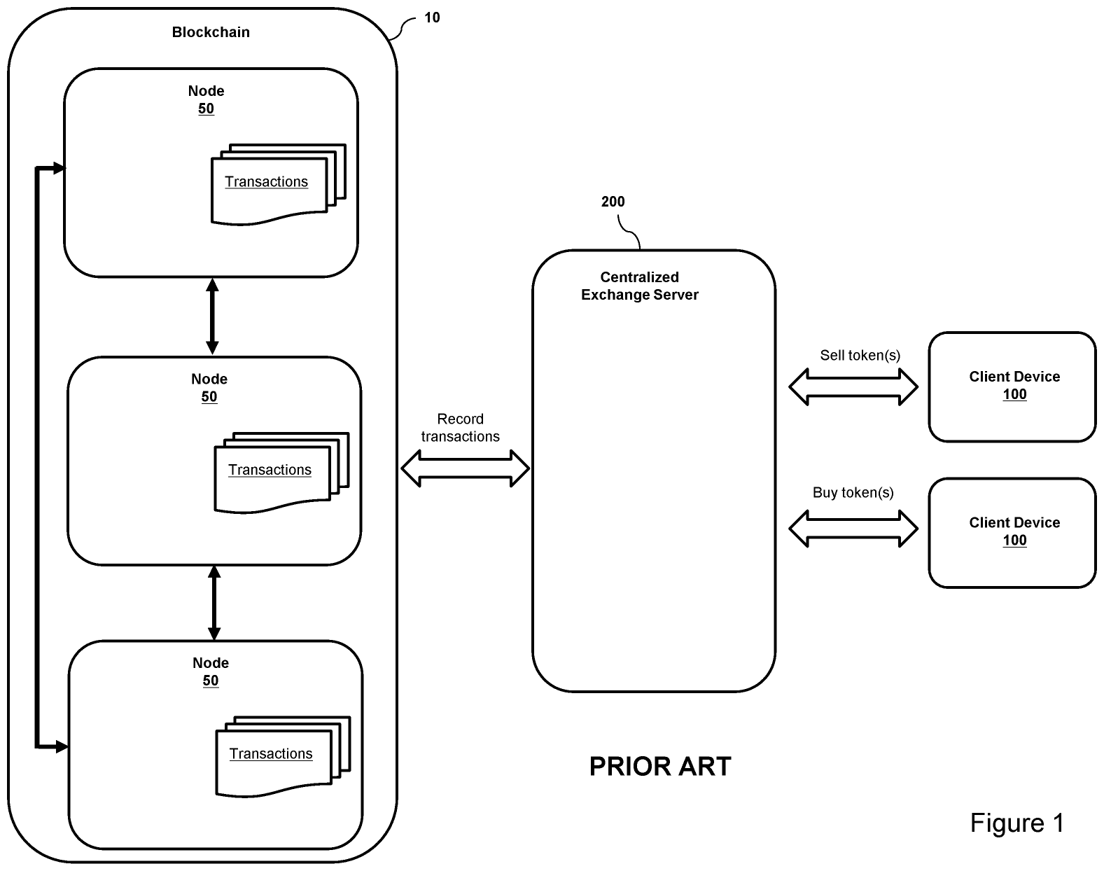

Referring now to FIG. 1, a centralized architecture based on a centralized exchange server for trading digital tokens, and recording some or all transactions to a blockchain, according to the prior art, is represented.

A centralized exchange server 200 provides functionalities allowing clients to trade digital tokens. A client uses a client device 100 to interact with the centralized exchange server 200 to perform a transaction. The interactions are performed via one or more communication networks (not represented in the Figures for simplification purposes) allowing communications between the client device 100 and the centralized exchange server 200, as is well known in the art.

The centralized exchange server 200 is a dedicated computing device having significant processing power (e.g. a server with a plurality of processors operating in parallel), significant memory capacities, significant network communication throughput, etc. Alternatively, the centralized exchange server 200 is implemented by a cluster of computing devices operating in parallel to provide the functionalities of the centralized exchange server 200. The cluster of computing devices provides the following advantages: increased computational capabilities, redundancy, etc.

The client device 100 comprises any type of computing device which can be used by a client, such as a smartphone, a tablet, a laptop, a desktop, etc.

The particularity of the centralized architecture illustrated in FIG. 1 is that a client device 100 initiating an initial transaction needs one or more other client devices 100 initiating complementary transaction(s). In the rest of the description, the object of a transaction will be referred to as a number of digital tokens (the number can be a fraction of a digital token, for example 0.01 digital token). Thus, a buying transaction of a number of digital tokens is executed only if one or more counterparts initiate a selling transaction for the same number of digital tokens. Similarly, a selling transaction of a number of digital tokens is executed only if one or more counterparts initiate a buying transaction for the same number of digital tokens.

In the context of cryptocurrencies, a digital token is a cryptocurrency coin (e.g. an Ethereum coin). A transaction consists in buying or selling a fraction of a cryptocurrency coin, one cryptocurrency coin or several cryptocurrency coins. In the rest of the description, we will use the terminology cryptocurrency token when referring to cryptocurrency coins.

The principles of operations of a centralized marketplace for cryptocurrencies (or other types of digital tokens) are similar to the principles of operations of other types of centralized marketplaces well known in the art, such as a marketplace for trading stocks, bonds, utilities, etc. Therefore, the functionalities of the centralized exchange server 200 will not be described in the present description.

FIG. 1 illustrates an exemplary use case where a first client interacts (via its client device 100) with the centralized exchange server 200 to sell a number A of digital tokens (e.g. 5 Ethereum tokens). The transaction can only go through if the centralized exchange server 200 finds at least one other user interacting (via its client device 100) with the centralized exchange server 200 to buy the same number A of digital tokens.

An exemplary set of transactions includes user 1 selling 5 Ethereum tokens and user 2 buying 5 Ethereum tokens. Another exemplary set of transactions includes user 1 selling 5 Ethereum tokens, user 2 buying 3 Ethereum tokens and user 3 buying 2 Ethereum tokens.

One functionality of the centralized exchange server 200 is to determine a value of each digital token traded via the centralized exchange server 200. The value of the digital token varies over time, based on the transactions performed by the clients. As is well known in the art, the value of the digital token is determined by offer and demand for the digital token. In the case of cryptocurrencies, the value of a digital token is generally expressed in a fiat currency, e.g. Canadian dollar (CAD) or US dollar (USD).

For example, a client buying a number A of digital tokens via the centralized exchange server 200 pays an amount in fiat currency (e.g. a number of CAD) corresponding to the number A of digital tokens to the owner of the centralized exchange server 200. For example, 4000 CAD are paid for 2 Ethereum tokens if the value of the Ethereum token when the transaction is performed is 2000 CAD. A transaction fee is also paid to the owner of the centralized exchange server 200.

In another example, a client selling a number B of digital tokens via the centralized exchange server 200 receives an amount in fiat currency (e.g. a number of CAD) corresponding to the number B of digital tokens from the owner of the centralized exchange server 200. For example, 6000 CAD are received for 3 Ethereum tokens if the value of the Ethereum token when the transaction is performed is 2000 CAD. A transaction fee is also paid to the owner of the centralized exchange server 200.

It should be noted that in a centralized trading architecture, the owner of the centralized exchange server 200 does not own a provision of digital tokens and a provision of the collateral (e.g. Canadian dollar) used for trading the digital tokens. The digital tokens and collateral are exchanged between the buyers and the sellers of the digital tokens, the centralized exchange server 200 acting as an intermediate facilitating the transaction between the two parties.

The centralized exchange server 200 may allow the trading of the digital tokens in different fiat currencies (e.g. Canadian dollar, US dollar, Euro, etc.). Furthermore, more than one type of digital token may be traded via the centralized exchange server 200 (e.g. Ethereum and at least one other type of cryptocurrency like Bitcoin).

As is well known in the art, the centralized exchange server 200 interacts with a blockchain comprising a plurality of nodes for recording a subset of the transactions performed by the centralized exchange server 200. The blockchain recorded transactions generally only consist of transactions for adding or removing digital tokens to the centralized exchange server, but may include other types of transactions. The majority of the centralized exchange transactions are never recorded to the blockchain and are private (only available for review by the centralized exchange server operators). The principle of a blockchain is that each transaction is recorded on at least a plurality of the nodes. A more detailed description of the blockchain will be provided in the following.

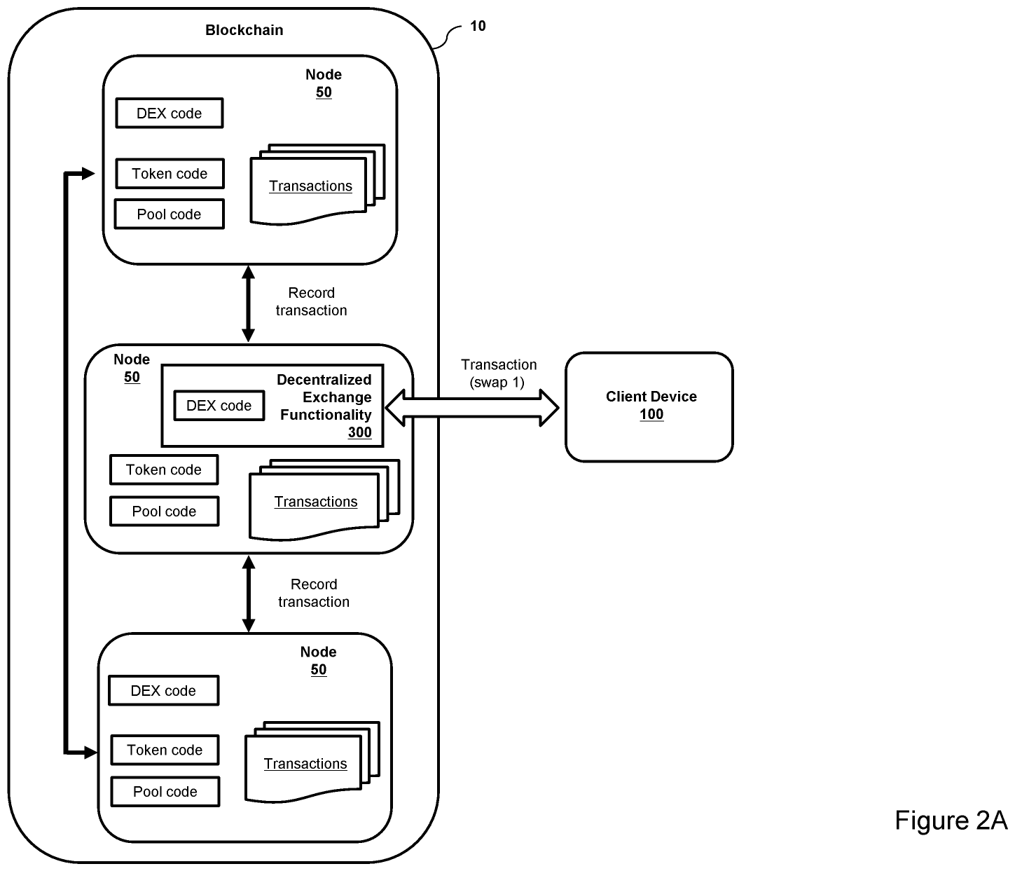

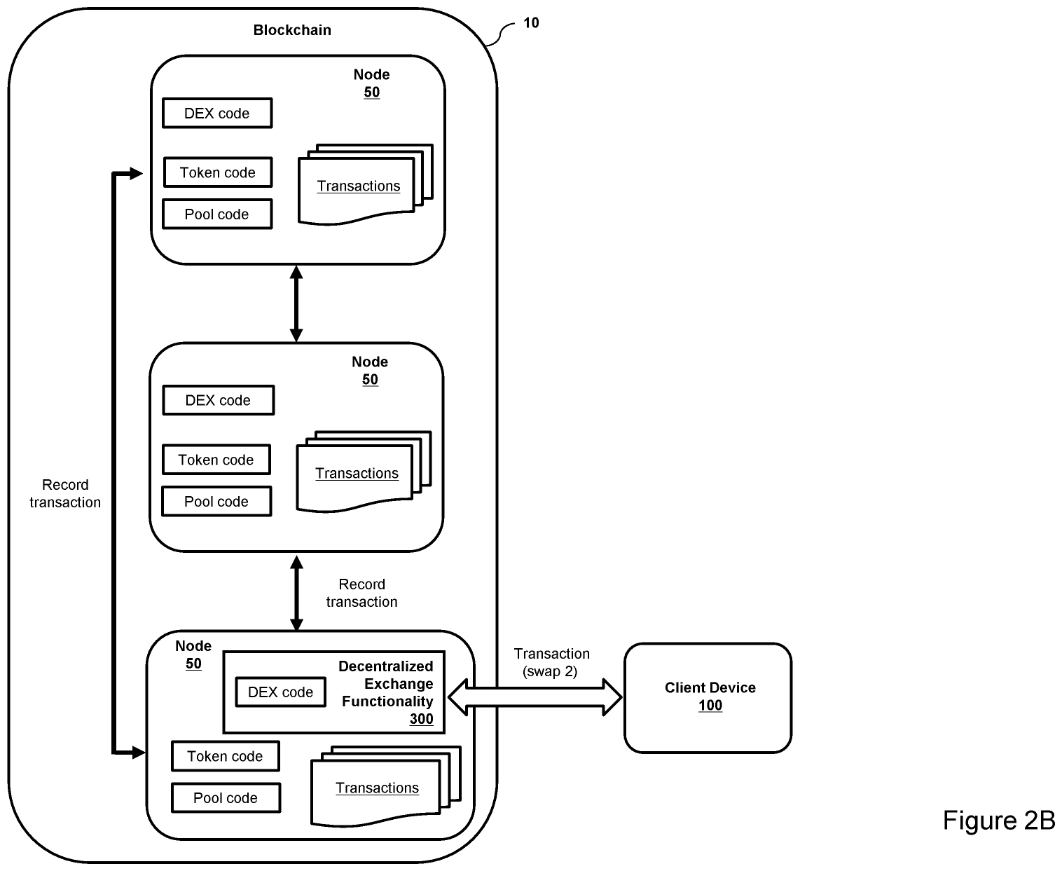

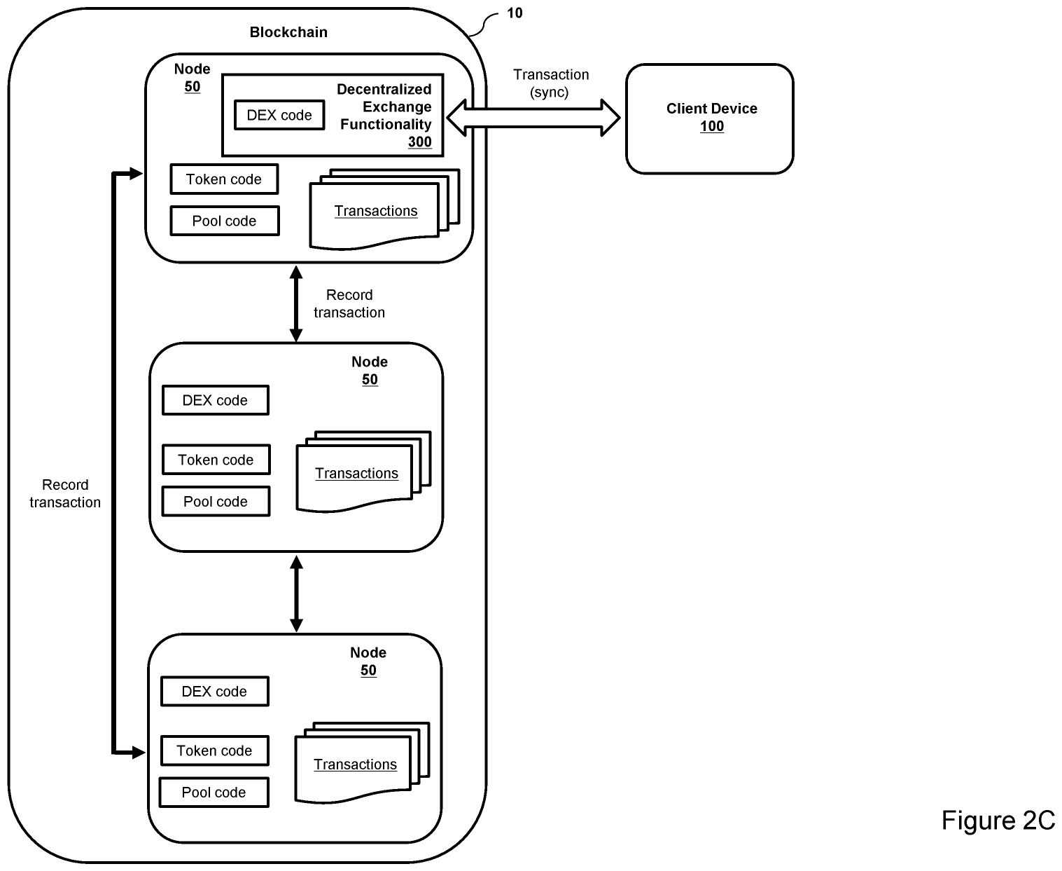

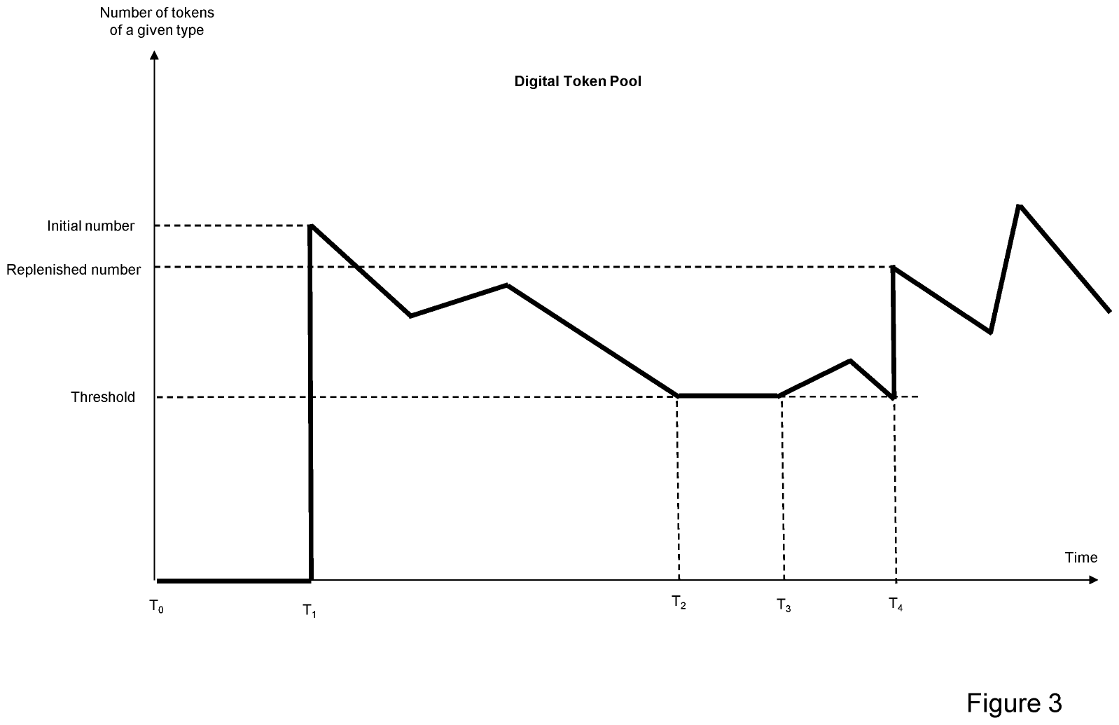

Referring now concurrently to FIGS. 2A, 2B, 2C and 3, a decentralized exchange (DEX) architecture based on a decentralized exchange functionality implemented by nodes of a blockchain for performing digital token transactions is represented.

The DEX architecture illustrated in FIGS. 2A-C aims at providing the same type of service (trading digital tokens) as the architecture illustrated in FIG. 1, by means of a DEX functionality 300.

A blockchain 10 comprising a plurality of nodes 50 is represented in FIGS. 2A-C. Only three nodes 50 are represented for simplification purposes. However, a blockchain 10 may comprise any number of nodes 50.

Compared to the centralized architecture of FIG. 1, the decentralized architecture of FIGS. 2A-C has at least the following differentiating feature: one of the nodes 50 of the blockchain 10 plays the role of a DEX server by implementing a DEX functionality 300. The client device 10 interacts with the DEX functionality 300 in a manner similar to the interactions of the client devices 100 of FIG. 1 with the centralized exchange server 200.

Each node 50 of the blockchain 10 stores multiple software codes, the execution of one of the software codes by a given node 50 allowing the given node 50 to implement a functionality associated to the executed software code. The nodes 50 store DEX software code(s) (referred to as DEX code in the Figures for simplification purposes). A node 50 executing a DEX software code implements the DEX functionality 300, playing the role of a DEX server with respect to the client device 100. The nodes 50 also store token software code(s) (referred to as token code in the Figures for simplification purposes) for each digital token managed via the blockchain 10. A node 50 executing a token software code of a digital token implements a digital token management functionality. The nodes 50 also store pool software code (referred to as pool code in the Figures for simplification purpose) for each digital token pool managed via the blockchain 10. A node 50 executing a pool software code of a digital token pool implements a digital token pool functionality.

The nodes 50 of the blockchain 10 also store transactions related to an account (also referred to as a ‘digital wallet’) and transactions related to digital token pools. A digital wallet is well known in the art. A digital wallet is associated with a client and can store a plurality of digital tokens and amounts (in some instances, the digital tokens consist of a cryptocurrency). A digital wallet is identified by a unique address (a public key) allocated to the digital wallet at its creation. The client interacts with the DEX functionality 300 via the client device 100 to manage his digital wallet (e.g. swap digital tokens). The blockchain 10 does not store the number of digital tokens present in the digital wallet, but stores all the transactions (e.g. swaps) affecting the digital wallet. Thus, in order to determine the current number of digital tokens present in the digital wallet, all the transactions related to the digital wallet recorded by the blockchain 10 need to be consolidated, to determine the current number of digital tokens present in the digital wallet. With respect to the digital token pools, the interactions with a digital token pool and the transactions related to a digital token pool will be described in details in the following.

A plurality of digital token pools are managed via the blockchain 10, more specifically by the DEX functionality 300 (implemented by the DEX software code(s)) executed for each digital token pool by each node 50 of the blockchain 10. Each transaction related to the digital tokens comprised in the digital token pools is recorded in the blockchain 10 (more specifically in at least some of the nodes 50 of the blockchain 10), and a client performing a transaction does not need one or more counterpart clients performing corresponding transaction(s).

A digital token pool generally comprises two types of digital tokens, for example Ethereum tokens and digital tokens pegged to the price of one (1) milligram of fine gold or one (1) United States Dollar (USD). However, a digital token pool may comprise more than two types of digital tokens. In the rest of the description, we will consider digital token pools with only two types of digital tokens. However, a person skilled in the art would readily understand that the concepts and functionalities described in the rest of the description can be generalized to digital token pools comprising more than two types of digital tokens.

The digital token pools are created with an initial number of each type of digital tokens. Generally, the initial number of each type of digital tokens aims at having the same initial monetary value for each type of digital tokens (the monetary value of the initial number of the first type of digital tokens is substantially the same as the monetary value of the initial number of the second type of digital tokens). The number of digital tokens in a given digital token pool fluctuates based on the transactions (mints, swaps, burns, and syncs) performed by blockchain users. Furthermore, at any time, digital tokens may be added to or retrieved from a given digital token pool via the DEX functionality 300 of a node 50. One objective of the owner of a digital token pool is to maintain its stability by keeping as close to a 50/50 ratio of digital tokens as possible.

A transaction performed by a client involves a digital token pool (comprising digital tokens) managed by the blockchain 10. The transaction is performed through a DEX functionality 300 implemented by one of the nodes 50 of the blockchain 10. As mentioned previously, any node 50 of the blockchain 10 is capable of playing the role of a DEX server (by implementing the DEX functionality 300) and interacting with the client device 100 of the client for performing the transaction. For example, a client located in Canada interfaces with a node 50 of the blockchain 10 located in Canada (playing the role of a DEX server for the client). Similarly, a client located in the USA interfaces with another node 50 of the blockchain 10 located in the USA (playing the role of a DEX server for the client).

The client acquires one type of digital token of the digital token pool in exchange for contributing digital token(s) of the other type to the digital token pool. This operation is referred to as a swap. The DEX functionality 300 determines in (substantially) real time an exchange rate between digital tokens of the first type and digital tokens of the second type.

For example, we consider a digital token pool comprising Ethereum tokens and USD digital tokens. The digital token pool is created with 100 Ethereum tokens and 200 000 USD digital tokens.

Referring more particularly to FIG. 2A, a first client interacts (via its client device 100) with the DEX functionality 300 implemented by a first node 50 (e.g. located in Quebec) to perform a first transaction: acquiring 5 Ethereum tokens. At the time of this first transaction, the exchange rate of the Ethereum token is determined to be 2000 USD digital tokens for one Ethereum token. Thus, the first client contributes 10 000 USD digital tokens. After completion of the first transaction, the digital token pool comprises 95 Ethereum tokens and 210 000 USD digital tokens. Furthermore, a transaction fee is also paid by the client for performing this swap operation. For example, if the transaction fee is 0.3%, the client contributes 10 000+10 000*0.3%=10 030 USD digital tokens to the digital token pool. Adjusted for the transactions, the digital token pool comprises 210 030 USD digital tokens at the end of the transaction.

Referring more particularly to FIG. 2B, a second client interacts (via its client device 100) with the DEX functionality 300 implemented by a second node 50 (e.g. located in British Columbia) to perform a second transaction: selling 10 Ethereum tokens. At the time of this second transaction, the exchange rate of the Ethereum token is determined to be 2100 USD digital tokens for one Ethereum token. Thus, the second client receives 21 000 USD digital tokens (minus 60 for the transaction fee of 0.3%). After completion of the second transaction, the digital token pool comprises 105 Ethereum tokens and 189 000 USD digital tokens (plus 60 for the transaction fee of 0.3%).

As mentioned previously, the first and second transactions are totally independent from one another. The first client does not need counterpart client(s) to perform the first transaction. Similarly, the second client does not need counterpart client(s) to perform the second transaction. Thus, an advantage of the decentralized architecture illustrated in this example is that it provides more liquidity in comparison to a centralized architecture.

Unlike the centralized exchange architecture, all transactions are recorded on every node 50 on the blockchain 10. The immutable transaction data are publicly available to any client with access to the blockchain 10.

As mentioned previously, the blockchain 10 is capable of managing a plurality of digital token pools. Furthermore, a variety of types of digital tokens may be used in the digital token pools. The types of digital tokens include cryptocurrency tokens (e.g. Ethereum, Bitcoin, etc.), fiat currencies tokens (e.g. CAD digital tokens, USD digital tokens, Euro digital tokens, etc.), utility tokens, digital tokens backed by a precious metals, financial asset tokens, tangible asset tokens, lending tokens, etc. Transactions affecting the digital token pools managed by the blockchain 10 occur simultaneously, in near-real time (from sub-second up to 13 seconds to record a block of transactions, depending on the blockchain), each transaction being supported by one of the nodes 50 of the blockchain 10 playing the role of a decentralized server (via the DEX functionality 300). The digital token pools are not represented in FIGS. 2A-C, because a digital token pool has no existence per se. For example, the number of digital tokens present in a digital token pool is not stored in the nodes 50. It is calculated in real time when needed, by consolidating the transactions affecting the digital token pool which have been recorded in the blocks (stored by the nodes 50) of the blockchain 10.

As is well known in the art, the transaction consisting for a client to acquire a first type of digital tokens from a digital token pool by contributing a second type of digital tokens to the digital token pool is referred to as a swap. Furthermore, as mentioned previously, the DEX functionality 300 determines in near-real time the exchange rate between the two types of digital tokens stored in a digital token pool. The exchange rate is determined by one or more algorithms implemented by the digital token pool software code executed by the node 50 implementing the DEX functionality 300. The algorithm takes into consideration data internal to the blockchain 10 (e.g. data in relation to the swapping operations previously performed on the digital token pool and stored by the nodes 20 of the blockchain 10) and optionally external data collected from other entities than the blockchain 10.

As mentioned previously, each digital token pool managed by the blockchain 10 is initialized with a given number of digital tokens of each type. Then, the number of digital tokens of each type present in a given digital token pool varies over time based on the swapping transactions involving this given digital token pool. Various entities may contribute to the initial number of digital tokens of each type present in the digital token pool managed by the blockchain. These entities receive a financial reward based on the aforementioned fees collected for each swap transaction involving the digital token pool for having contributed to the initial number of digital tokens present in the digital token pool. After some time, a contributing entity may retrieve at least a portion of its initial contribution in digital tokens to a given digital token pool to which the entity contributed, or may add an additional contribution in digital tokens to the given digital token pool. Entities which have not contributed initially, may contribute at a later stage, to increase the number of digital tokens of the pool, rebalance the number of digital tokens of one type with respect to the other type of digital tokens, etc.

The blockchain 10, via the DEX functionality 300, calculates the number of digital tokens of each type in a digital token pool, to ensure that there is a sufficient quantity to perform transactions. However, it is possible to have a digital token pool that only has a type of digital token left in it because users have swapped (almost) all of another type. For example, if the number of digital tokens of a given type present in a digital token pool is below the minimum number of digital tokens of this type requested in a swap transaction, then the swap transaction is rejected. In another example, a threshold is defined for each type of digital token of a digital token pool. If the number of digital tokens of a given type in the digital token pool is below its corresponding threshold, one or more actions may be taken by the DEX functionality 300 of the blockchain 10. An example of action consists in rejecting a swap transaction. Another example of action consists in only allowing swapping transactions which increase the number of digital tokens of the given type in the digital token pool. Another example of action consists in having the number of digital tokens of the given type replenished via contributions in digital tokens to the digital token pool by other entities.

The allocation of digital tokens to a given digital token pool (at the initial stage or at a later stage for replenishing purposes) is a transaction referred to as a sync transaction. Referring more particularly to FIG. 2C, a sync transaction performed by a client device 100 is illustrated. The client (e.g. an individual, a corporation, etc.) interacts (via its client device 100) with the DEX functionality 300 implemented by a third node 50 (e.g. located in Sydney, Australia) to perform the sync transaction. The number of digital tokens of at least one of the two types of digital tokens of the given digital token pool is increased via this sync transaction.

Referring more particularly to FIG. 3, an exemplary curve representing the evolution over time of the number of digital tokens of a given type in a digital token pool is provided. FIG. 3 is for illustration and description purposes only, and does not aim at providing a precise representation of such a curve. Furthermore, although a digital token pool comprises a plurality of types of digital tokens, only one type of digital tokens (Ethereum) is represented in FIG. 3 for simplification purposes.

An empty digital token pool is created at a time T₀. At time T₁, a client node 100 (as illustrated in FIG. 2C) performs a sync transaction to contribute an initial number of Ethereum tokens and equivalent value of one or more other digital tokens to the digital token pool. Between time T₁ and T₂, the number of digital tokens (Ethereum and others) in the digital token pool varies based on swap transactions performed by client devices 100 (as illustrated in FIGS. 2A and 2B). At time T₂, the number of Ethereum tokens in the digital token pool reaches a pre-defined threshold. At this point, only swap transactions increasing the number of Ethereum tokens in the digital token pool (a client sells Ethereum tokens) are allowed. Between time T₂ and T₃, no such transaction occurs. At time T₃, at least one swap transaction increasing the number of Ethereum tokens in the digital token pool occurs. Between time T₃ and T₄, the number of Ethereum tokens in the digital token pool varies based on swap transactions performed by client devices 100 (as illustrated in FIGS. 2A and 2B). At time T₄, the number of Ethereum tokens in the digital token pool reaches the pre-defined threshold again. This time, a client node 100 (as illustrated in FIG. 2C) performs a sync transaction to contribute a number of Ethereum tokens to the digital token pool for replenishing the digital token pool to a replenished number of Ethereum tokens. After time T₄, the number of Ethereum tokens in the digital token pool varies based on swap transactions performed by client devices 100 (as illustrated in FIGS. 2A and 2B).

Two other types of transactions related to digital tokens are well known in the art. A mint transaction consists in creating new digital token(s) of a given type. A burn transaction consists in deleting digital token(s) of a given type. After a burn transaction, a burnt digital token is no longer in circulation and cannot be recovered later. In the digital token ecosystem, various entities are involved in the minting and burning processes. For example, individuals as well as specialized corporations may be involved in the minting process of a given type of digital token.

Furthermore, digital tokens may have associated rewards (also referred to as incentives) for keeping them over a given period of time. For example, one percent of the holdings in a given type of digital token is given as a reward every 30 days. The rewarding process includes at least one of two transactions: an optional mint transaction for creating new digital token(s) and a required transfer transaction for allocating the newly created digital token(s) to the owner of the holdings for which the rewarding process is triggered. A transfer transaction is another type of transaction which can be recorded on a blockchain. A sync transaction can be considered as a one-way transfer, while a swap transaction can be considered as a two-way transfer.

Blockchains are used for recording any type of transaction (swap, mint, burn, sync, etc.) occurring on a digital token of a given type. The blockchain technology is well known in the art for providing a decentralized architecture to record each transaction in a reliable and secure manner. Each block of data of the blockchain is dedicated to the recording of a single transaction or a group of transactions. In the rest of the description, a block of data of the blockchain will be referred to as data block. A data block is stored on all the nodes of the blockchain (or at least on a plurality of nodes of the blockchain).

Referring back to FIGS. 2A-C, each node 50 (or at least a plurality of the nodes 50) of the blockchain 10 store all the data blocks which have been created for recording all the transactions (e.g. swap for FIGS. 2A and 2B, sync for FIG. 2C) related to the digital token pools managed by the blockchain 10. Other transactions performed under the management of the blockchain 10 (e.g. mint or burn operations) are also recorded in data blocks stored by each node 50 (or at least a plurality of the nodes 50) of the blockchain 10.

For each transaction involving the blockchain 10, transaction data related to the transaction are recorded in one or more data blocks. Examples of transaction data include the time of occurrence of the transaction, a unique identification of the node 50 having performed the transaction through its DEX functionality 300, identification of the (previous) owner of the digital tokens before occurrence of the transaction, identification of the (new) owner of the digital tokens after occurrence of the transaction, number of digital tokens involved in the transaction (possibly of different types, for instance in a swap transaction between type 1 and type 2), software code(s) executed in relation to the transaction (e.g. a smart contract), etc.

For example, in the case of a swap transaction involving a client and a digital token pool, the client is the previous owner, and the digital token pool is the new owner for digital tokens of the first type (e.g. Ethereum coins) involved in the transaction. The client is the new owner, and the digital token pool is the previous owner for digital tokens of the second type (e.g. CAD stable coins) involved in the transaction. The swap transaction involves the client transferring a number of digital tokens N of the first type (e.g. Ethereum coins) from a digital wallet to the digital token pool and the digital token pool transferring a corresponding number of digital tokens M of the second type (e.g. CAD stable coins) to the digital wallet of the client. The relation between N and M is based on the exchange rate between the digital tokens of the first type and the digital tokens of the second type, as determined by the blockchain 10. Furthermore, a fee is calculated for the transaction, resulting in a number of digital tokens F of the second type (e.g. CAD stable coins) transferred from the digital wallet of the client to the digital token pool. The following data are recorded in one or more data blocks: identity of the client (unique address of his digital wallet), N digital tokens of type 1 added to the digital wallet, M+F digital tokens of type 2 subtracted from the digital wallet, identity of the digital token pool (unique address of the digital token pool), N digital tokens of type 1 subtracted from the digital token pool, M+F digital tokens of type 2 added to the digital token pool.

As is well known in the art, a hash value is calculated for a data block corresponding to one (or more) transaction (based on the transaction data and additional information, such as the hash value of the previous data block in the blockchain).

The calculation of the hash value is based on the distributed architecture of validation nodes 50 illustrated in FIGS. 2A-C. The DEX functionality 300 performing the transaction transmits the transaction data (to be recorded in a data block) to a plurality of nodes 50 implementing a validation functionality (referred to in the following as validation nodes 50). Each validation node 50 independently calculates a hash value based on the transaction data. The algorithms used for calculating the hash value are normalized and each validation node 50 uses the same algorithms for the calculation of the hash value. The calculation of the hash value is a very complex task involving a lot of processing power and is potentially prone to errors. Furthermore, malicious validation nodes 50 may intentionally provide an erroneous value for the hash value. Thus, the validation nodes 50 participating to the calculation of the hash value implement a negotiating protocol for determining a final value of the hash value based on the contribution of each participating validation node 50. The negotiation protocol allows the participating validation nodes 50 to come to a consensus with respect to the value of the hash value. For example, the consensus consists in having substantially 51% of the participating validation nodes 50 agreeing on the same value for the hash value.

The agreed upon value of the hash value is shared between all the nodes 50 of the blockchain 10 and added to the data block corresponding to the transaction. The data block is then considered as finalized and is added to the blockchain 10, by storing the finalized data block on every node 50 of the blockchain 50.

As mentioned previously with respect to the centralized exchange server 200 of FIG. 1, the nodes 50 are dedicated computing devices having significant processing power (e.g. a server with a plurality of processors operating in parallel), significant memory capacities, significant network communication throughput, etc.

Referring now concurrently to FIGS. 2A-C, 4A and 4B, a platform 400 for analyzing transactions performed by a plurality of DEX functionalities 300 on a plurality of nodes 50 of a plurality of blockchains 10 is represented. The platform 400 collects transaction data related to the transactions from a plurality of entities including blockchains 10, processes the transaction data to generate client data, and transmits the client data to client devices 500.

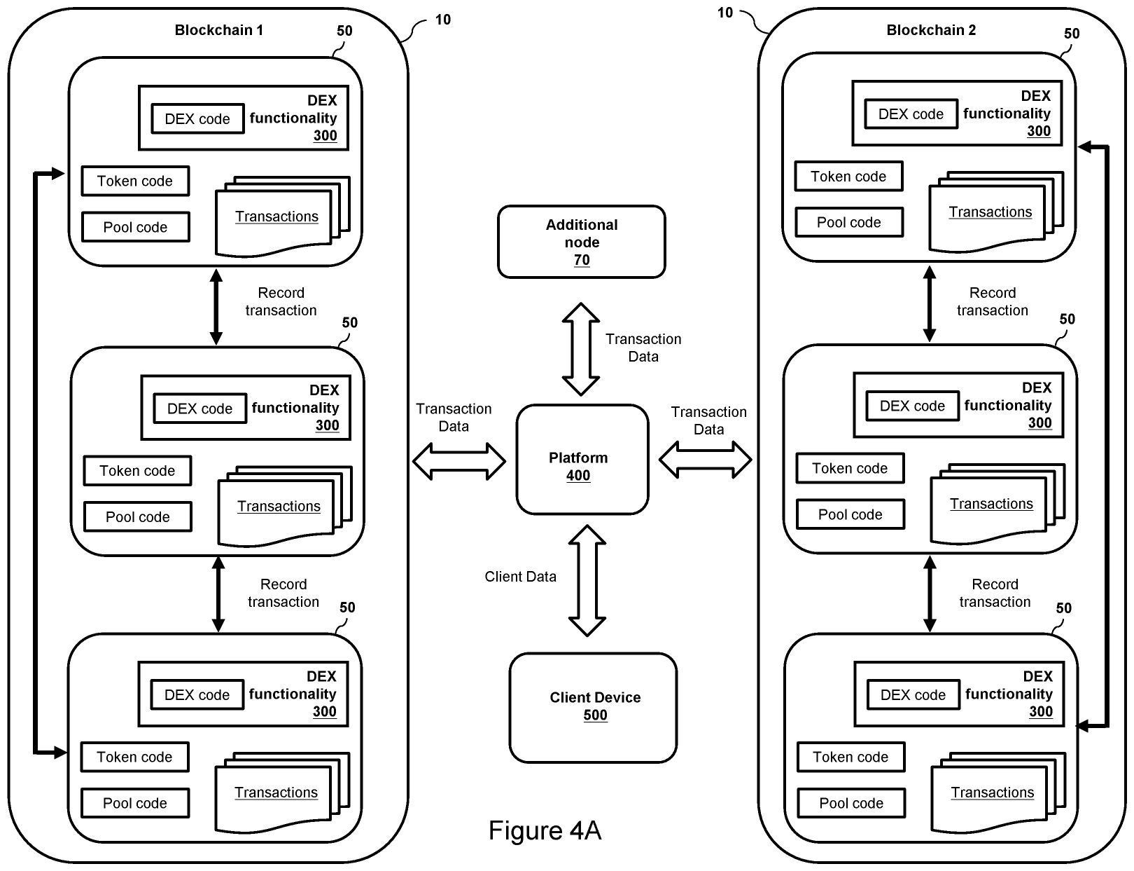

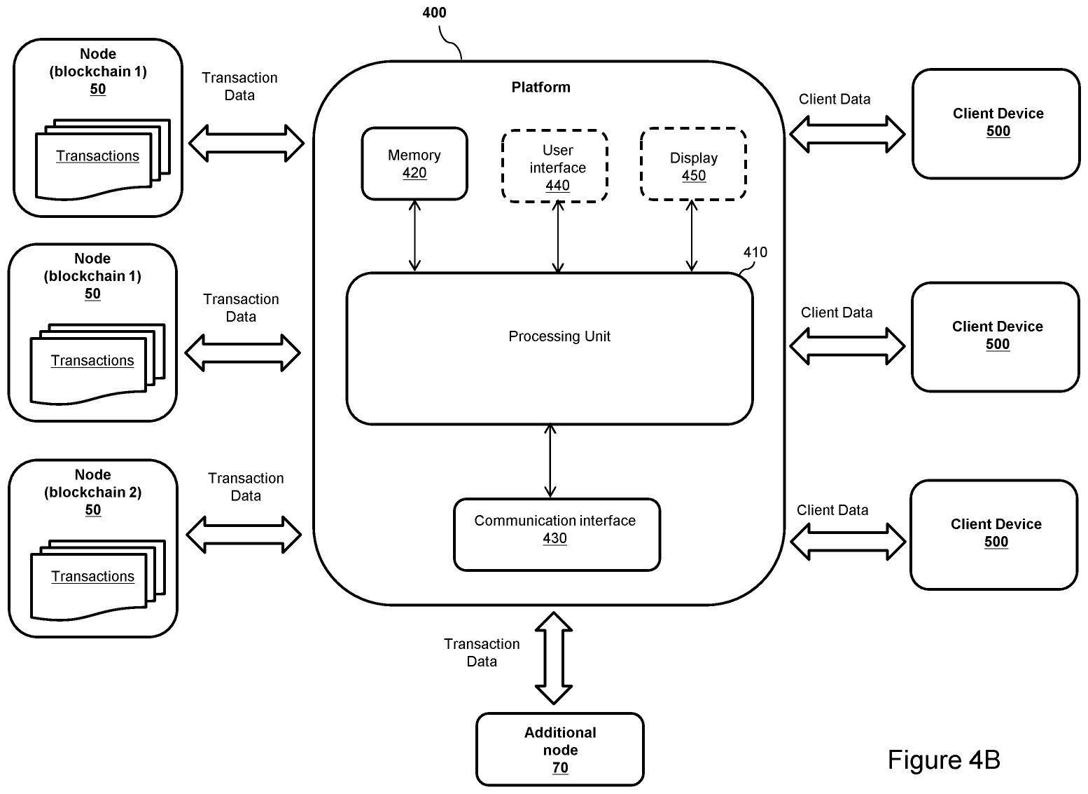

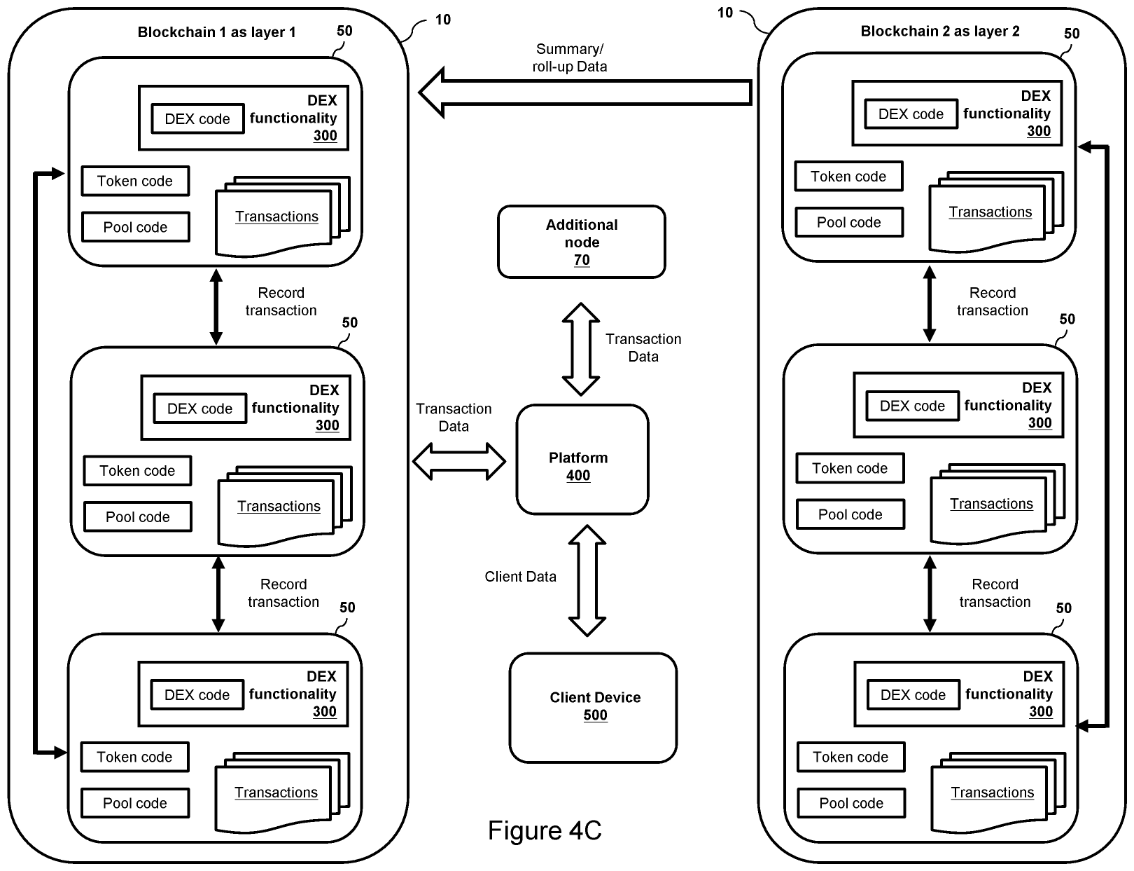

The transaction data are collected from the plurality of nodes 50 of a plurality of blockchains 10 corresponding to the blockchain 10 illustrated in FIGS. 2A-C. Only two blockchains respectively comprising three nodes 50, blockchain 1 and blockchain 2, are represented in FIG. 4A for simplification purposes. However, the transaction data may be collected from any number of blockchains 10 comprising any number of nodes 50. Furthermore, in FIG. 4B, only three of the six nodes 50 of FIG. 4A are represented for simplification purposes.

Examples of transaction data have been described previously in relation to FIGS. 2A-C and correspond to transactions (e.g. swap, sync, mint and burn) performed by the blockchains 10. As mentioned previously, the transactions involve digital token pools, digital wallets, individual digital tokens, etc. The transaction data are stored in the data blocks of the blockchains 310. The transaction data stored in the data blocks of blockchains 310 have been validated, as described previously in relation to FIGS. 2A-C. Therefore, the transaction data collected by the platform 400 from the blockchains 10 are considered to be authentic and accurate in most cases. A dedicated algorithm is implemented for improving the authenticity and accuracy of the collected transaction data.

In a first implementation, the platform 400 collects data blocks of the blockchains 310. The platform 400 then performs the extraction of the relevant transaction data from the collected data blocks. Collecting the entire data blocks allows the platform 400 to validate the authenticity of the transaction data stored in the data blocks. In an alternative implementation, the nodes 50 perform the extraction of the relevant transaction data from the data blocks stored in the nodes 50, and directly transmit the extracted transaction data to the platform 400. This implementation is less secure, since the platform 400 does not have directly access to the data blocks, which prevents the platform 400 from validating the authenticity and accuracy of the transaction data transmitted by the nodes 50.

Optionally, the transaction data are also collected from one or more additional nodes 70. The transaction data collected by the platform 400 from the additional node(s) 70 also need to be considered as authentic and accurate, in order to be taken into consideration by the platform 400.

At least some of the client devices 500 illustrated in FIGS. 4A-B correspond to the client device 100 illustrated in FIGS. 2A-C. Since a large number of blockchains 10 and corresponding digital token pools are available, the owner of a client device 500 intending to perform a swap transaction or a sync transaction involving a digital token pool has a plurality of possibilities to choose from. Based on the particular needs and requirements of the owner of a client device 500, some blockchains 10/corresponding digital token pools may be more adapted than others to these particular needs and requirements. The platform 400 acts as a data broker, capable of interacting with the plurality of nodes 50 of the plurality of blockchains 10 (and optionally with the additional node(s) 70) to collect their transaction data, and to transform the collected transaction data into meaningful client data, which can be used by each client devices 500 to select the appropriate blockchain 10/corresponding digital token pool.

In an exemplary implementation, the platform 400 implements a database of historical transaction data based on the transaction data collected from the plurality of nodes 50 of the plurality of blockchains 10 (and optionally from the additional node(s) 70). Various types of client data are calculated based on the information stored in the database. Examples of client data comprise metrics related to the transactions performed on the digital token pools managed by the blockchains 10, alerts generated with respect to the values of metrics related to digital token pools, predictions related to future transactions performed on the digital token pools, etc.

Following is a description of the components of the platform 400.

Referring more particularly to FIG. 4B, the platform 400 comprises a processing unit 410, memory 420, a communication interface 430, optionally a user interface 440, and optionally a display 450. The platform 400 may comprise additional components not represented in FIG. 4B for simplification purposes (e.g. an additional communication interface 430). The platform 400 may consist of one of the following computing devices: a computer, a server, etc.

The processing unit 410 comprises one or more processors (not represented in FIG. 4B) capable of executing instructions of a computer program. Each processor may further comprise one or several cores.

The memory 420 stores instructions of computer program(s) executed by the processing unit 410, data generated by the execution of the computer program(s), data received via the communication interface 420, etc. Only a single memory 420 is represented in FIG. 4B, but the platform 400 may comprise several types of memories, including volatile memory (such as a volatile Random Access Memory (RAM), etc.) and non-volatile memory (such as a hard drive, solid-state drive (SSD), electrically-erasable programmable read-only memory (EEPROM), flash, etc.). The database mentioned previously is an exemplary implementation of a data structure for storing the collected transaction data stored in the memory 420.

The communication interface 430 allows the platform 400 to exchange data with several devices (e.g. the nodes 50, optionally one or more additional nodes 70, the client devices 500, etc.) over one or more communication networks (not represented in FIG. 4B for simplification purposes). The term communication interface 430 shall be interpreted broadly, as supporting a single communication standard/technology, or a plurality of communication standards/technologies. Examples of communication interfaces 430 include a wireless (e.g. Wi-Fi, cellular, wireless mesh, etc.) communication module, a wired (e.g. Ethernet) communication module, a combination of wireless and wired communication modules, etc. The communication interface 430 usually comprises a combination of hardware and software executed by the hardware, for implementing the communication functionalities of the communication interface 430.

Although not represented in FIG. 4B for simplification purposes, the nodes 50, the one or more additional nodes 70, and the client devices 500 also comprise at least the following components: a processing unit (comprising one or more processors), memory and a communication interface. The memory of the nodes 50 stores the data blocks of their respective blockchains.

Alternatively, the platform 400 is implemented by a cluster of computing devices (instead of a single computing device) having the same components as those represented in FIG. 4B, the cluster of computing devices providing redundancy and load balancing capabilities for implementing the functionalities of the platform 400.

### Collection and Validation of Transaction Data by the Platform 400

As mentioned previously, each blockchain 10 stores detailed information related to the transactions affecting the entities (e.g. digital token pools, accounts or digital wallets, individual digital tokens, etc.) under its control. The information is comprised in data blocks stored in the nodes 50 of the blockchains 10. In the following, we will focus on transaction data related to digital token pools.

By collecting data comprised in the data blocks stored in the nodes 50 of the blockchains 10, the platform 400 is capable of retrieving at least some of the following transaction data for each transaction involving a digital token pool (but is not limited to the following examples of transaction data): block chain headers, transfer event logs according to the ERC20 standard, transfer event logs according to the ERC721 standard, transfer event logs according to the BEP-20 standard, transfer event logs according to the ERC-1155 standard, transfer event logs according to the TRC-20 standard, and transfer event logs according to the SPL standard, constant product digital token pool logs, concentrated digital token pool logs, mint event logs, swap event logs, burn event logs, sync event logs, burn event logs (logs of the steps for performing multiple digital token deletions), collect event logs, flash event logs, initialize event logs, increase liquidity event logs, decrease liquidity event logs, contract states related to digital token balances, contract states related to digital token total supply, contract states related to digital tokens owed, identification of the node 50 (and blockchain 10) involved in the transaction, identification of the digital token pool involved in the transaction, time of occurrence of the transaction, number of digital tokens of the digital token pool affected by the transaction (e.g. number of digital tokens of type 1 swapped for digital tokens of type 2 in a swap transaction), transaction fees (in digital tokens) generated by the transaction, gas price for the transaction, identification of the account or digital wallet(s) involved in the transaction, etc.

The transaction data are received by the platform 400 from nodes 50 via the communication interface 430. More specifically, data blocks stored in the nodes 50 are received via the communication interface 430 from nodes 50 and the transaction data are extracted by the processing unit 410 from the received data blocks. Alternatively, as mentioned previously, the received transaction data only comprise a subset of the information contained in the data blocks, instead of the entire data blocks. The transaction data are stored in the memory 420. As mentioned previously, in an exemplary implementation, the processing unit 410 and the memory 420 implement a database for storing the transaction data. A database structure facilitates the analysis and processing of the transaction data, to generate corresponding metrics.

A dedicated software executed by the processing unit 410 is generally used for managing the task of collecting data from the nodes 50. For example, a robot software is configured to collect pre-defined data at regular intervals of time (e.g. every hour) by polling the nodes 50. The robot software updates the database upon generation of new transaction data based on the data collected from the nodes 50.

In general, for each transaction affecting a digital token pool of a given blockchain 10, the same transaction data are comprised in one data block stored in all (most of) the nodes 50 of the given blockchain 10. Thus, in theory, it is sufficient to collect data from a single node 50 of the given blockchain 10 to obtain the transaction data related to the transaction. However, to compensate potential errors in at least some of the transaction data stored at a given node 50, the following mechanisms is used. For example, the errors may be due to time delays when nodes 50 synchronize with each other.

For a given blockchain 10, data are collected from a number N of nodes 50 of the blockchain 10. The number N is the same for all the blockchains 10 (e.g. N=5). Alternatively, the number N varies from one blockchain 10 to another, based on specific characteristics of each blockchain 10.

For a given blockchain 10, the N nodes 50 are chosen based on various criteria associated to the nodes 50 (e.g. reputation, etc.). In a first implementation, the determination of the N nodes of a given blockchain 10 is static and does not vary over time. In a second implementation, the determination of the N nodes of a given blockchain 10 is dynamic and varies over time. For example, for a given blockchain 10, the number N may vary over time. Furthermore, for a given blockchain 10, the N nodes 50 of the given blockchain 10 used for collecting the data may change over time.

For a transaction (e.g. affecting a digital token pool) managed by the given blockchain 10, the platform 400 receives candidate transaction data related to the transaction from the N nodes 50. The processing unit 410 of the platform 400 executes a validation algorithm for determining validated transaction data based on the candidate transaction data received from the N nodes 50. Following is an example of a validation algorithm using different steps for determining the validated transaction data.

Step 1: compare the candidate transaction data of the N nodes 50.

Step 2: if the candidate transaction data are identical for all the N nodes 50, the validated transaction data consist of the identical candidate transaction data.

Step 3: if step 2 fails, but a majority of the N nodes 50 have identical candidate transaction data, the validated transaction data consist of the identical candidate transaction data of the majority of the N nodes 50. The number N needs to be odd for applying this step.

Step 4: if step 3 fails, the total number of transactions recorded by the N nodes 50 is taken into consideration to determine the validated transaction data.

Step 5: if step 4 fails, a reputation of the N nodes 50 (based on an evaluation of the accuracy of historical transaction data related to historical transactions stored at the N nodes 50, e.g. over an historical period of time, such as a day, a week, a month, etc.) is taken into consideration to determine the validated transaction data. For example, a reputation for each of the nodes 50 is maintained by scoring 1 point for each accurate data block and 0 point for each inaccurate data block. The total number of blocks captured by a given node 50 divided by the points scored by the given node 50 provides an accuracy score for the given node 50. The more accurate the node, the higher the probability that the node data will be used.

When the five steps evaluation process is completed, the processing unit 410 stores the validated transaction data determined by the validation algorithm in the memory 420. A simplified version of the validation algorithm (for example implementing only a subset of the aforementioned steps), or another version of the validation using different/additional criteria, may be used. Furthermore, the validation algorithm may determine that the candidate transaction data are not reliable, in which case no validated transaction data are stored in the memory 420 (the corresponding transaction is simply ignored).

Although the collection and validation of transaction data has been described in relation to a digital token pool, the previously described functionalities also apply to the collection of transaction data affecting an account or digital wallet, an individual digital token, etc.

Another functionality which can be implemented by the platform 400 consists in a vulnerability assessment of the software codes hosted on the nodes 50 of the blockchain(s) 10. Examples of software codes which can be assessed include the DEX code, the token code, the pool code (illustrated in FIG. 4A), etc. The platform 400 retrieves a software code that needs to be assessed from the node 50 where it is stored. The platform implements one or more algorithms adapted for accessing the vulnerability of the software code. A first exemplary algorithm is capable of detecting generic vulnerabilities which may affect any type of software code. Another exemplary algorithm is capable of detecting specific vulnerabilities which may affect a specific type of software code (e.g. the token code and/or the pool code). The outcome of the assessment of the software code by the algorithm(s) may take several forms: a score representative of the severity of the vulnerabilities, a number of vulnerabilities detected, a combination thereof, etc.

### Generation of Metrics by the Platform 400

In the following, the terminologies metric and type of metric will be used as following. A type of metric defines a mathematical formula (or an algorithm) for calculating a value related to a generic type of entity (e.g. digital token pools). A metric defines a value which is calculated by the mathematical formula (or algorithm) in relation to a given entity (e.g. a given digital token pool among a set of digital token pools). A metric may also be generated in relation to an entity that exists in a plurality of digital token pools managed by a plurality of blockchains 10.

The processing unit 410 processes the (validated) transaction data stored in the memory 420 to generate corresponding metrics. The values of the metrics are stored in the memory 420. A client device 500 sends a request to the platform 400 to receive the values of some of the metrics stored in the memory 420. The client request is received via the communication interface 430, processed by the processing unit 410 to retrieve the values of the requested metrics from the memory 420. The values of the requested metrics are then sent to the client device 500 via the communication interface 430. The metrics represent one type of client data sent by the platform 400 to the client devices 500.

In another configuration, upon reception of a push request from a client device 500, the platform 400 is configured to automatically send an update of the value(s) of one or more metrics each time a new value of the one or more metrics are calculated. Alternatively, or complementarily, the platform 400 is configured to automatically send an update of the last calculated value(s) of one or more metrics at a regular interval (e.g. every hour or every day).

The client request received from a client device 500 defines which types of metrics need to be transmitted (e.g. all of them or a selected subset of the available types of metrics), for which decentralized exchange 300 blockchain 10 (e.g. all of them or a selected subset of the blockchains 10 monitored by the platform 400), for which digital token pools of a given blockchain 10 (e.g. all of them or a selected subset of the digital token pools managed by the given blockchain 10), over which time period, etc.

Optionally, the platform 400 also provides the capability for a user of the platform 400 to use the user interface 440 for requesting the display of the values of some of the metrics stored in the memory 420 on the display 450.

In an exemplary implementation, the values of the metrics are stored in the database implemented by the processing unit 410 and the memory 420. The database structure facilitates the querying of particular metrics requested by the client devices 500. Additionally, some of the metrics may be calculated in real-time based on the transaction data stored in the memory 420, to accommodate particular requests from the client devices 500. For example, the values of pre-defined metrics are calculated over one or more pre-defined time periods (e.g. the time to mint one block over a minute, over an hour, over a day, over a week, over a month, over a quarter, over a year, etc.). Upon reception (and validation) of new transaction data from the nodes 50, the values of the corresponding pre-defined metrics are calculated by the processing unit 410 and stored in the memory 420. The platform 400 also provides the capability to calculate values of additional on-demand metrics, which are not calculated by default and stored in the memory 420. For example, an on-demand metric is a metric which value is calculated over a time period different from the pre-defined time periods (e.g. over 30 minutes). The value of the on-demand metric is calculated in real time by the platform 400, to accommodate a request from a client device 500 to receive the value of the on-demand metric.

Following are examples of metrics generated by the platform 400 based on the collected (and validated) transaction data: the deltas of digital token balances in a constant product digital token pool over a time period, the deltas of digital token balances for a user's position in a constant product digital token pool over a time period, the number of underlying digital tokens that is represented by a digital token pool and the deltas of this number over a time period, the number of underlying digital tokens that is represented by a concentrated digital token position over a time period (calculated as a function of the fixed values for that position and the state variables of the digital token pool, which change over the time period).

Following are other examples of metrics generated by the platform 400 based on the collected (and validated) transaction data: number of transactions performed by a given blockchain 10 over a time period, number of transactions performed on a given digital token pool managed by a blockchain 10 over a time period, number of transactions of a given type (e.g. swap, mint, burn, sync, etc.) performed by a given blockchain 10 over a time period, number of transactions of a given type (e.g. swap, mint, burn, sync, etc.) performed on a given digital token pool managed by a blockchain 10 over a time period, number of swap transactions of a given type of digital token performed by a given blockchain 10 over a time period, number of swap transactions of a given type of digital token performed on a given digital token pool managed by a blockchain 10 over a time period, number of digital tokens of a given type accumulated by a given digital token pool managed by a blockchain 10 as a reward for performing transactions (e.g. swap) over a time period, number (also referred to as volume) of digital tokens of a given type exchanged via a given blockchain 10 over a time period, number (also referred to as volume) of digital tokens of a given type exchanged via a given digital token pool managed by a blockchain 10 over a time period, number (also referred to as reserves) of digital tokens of a given type managed by a given digital token pool of a blockchain 10 at the first transaction performed over a time period, number (also referred to as reserves) of digital tokens of a given type managed by a given digital token pool of a blockchain 10 at the last transaction performed over a time period, number of digital tokens of a given type present in a given digital token pool managed by a blockchain 10 over a time period, ratio of the number of digital tokens of a first type versus the number of digital tokens of a second type present in a given digital token pool managed by a blockchain 10 over a time period, volatility or measured rate of change (as well as Sharpe ratio) in the value of a digital token in a digital token pool, a number of accounts or digital wallets managed by a blockchain 10 over a time period, a number of participants to transactions related to a digital token pool over a time period, etc.

A time period for which a metric is calculated is defined by a start time and a close time. Based on the type of metric, the calculation of the value of the metric over a time period based on transaction data may vary (e.g. calculate an average value, calculate a cumulative value, determine a maximum value, determine a minimum value, etc.). For example, a number of transactions performed over a time period is determined by adding all the relevant transactions performed during the time period (between the start time and the close time), as recorded in the collected transaction data.

In another example, the number of digital tokens of a given type present in a given digital token pool at the end of a time period is determined as follows. The number of digital tokens of the given type present in the given digital token pool at the beginning of the time period (start time) has been previously calculated and stored in the memory 420. All the transactions affecting the given type of digital token of the given digital token pool over the time period (e.g. transactions to add digital tokens of the given type or transactions to retrieve digital tokens of the given type, between the start time and the close time) are taken into consideration (in combination with the previously calculated value) to calculate the number of digital tokens of the given type present in the given digital token pool at the end of the time period.

In still another example, an average number of digital tokens of a given type present in a given digital token pool over a longer time period is determined as follows. The longer time period is divided into smaller time periods. The number of digital tokens of the given type present in the given digital token pool at the end of each smaller time period is calculated according to the previous example. Then, the average number of digital tokens over the longer time period is the average of the values calculated for each shorter time period.

Metrics related to a plurality of digital token pools (managed by the same or different blockchain(s) 10) are collected by a client device 500 and displayed on a display of the client device 500, allowing the user of the client device 500 to compare the plurality of digital token pools based on the values of the metrics and to determine which one of the plurality of digital token pools is best adapted to his needs. Alternatively, or complementarily, a robot software executed by the client device 500 automatically collects the metrics on a regular basis, the values of the collected metrics being stored in a memory of the client device 500 (e.g. for later display) and/or further processed by a dedicated software executed by the client device 500.

The collection of transaction data from a plurality of blockchains provides the capability to generate metrics taking into account transactions recorded on different blockchains. For example, transaction data related to transactions recorded on a first blockchain (e.g, Ethereum, using the first standard ERC-20) are combined with transaction data related to transactions recorded on at least one other blockchain (e.g, BNB Chain, using the second standard BEP-20) to generate global metrics (e.g. index or market metrics).

Although the generation of metrics has been described in relation to a digital token pool, the previously described functionalities also apply to the generation of metrics related to transaction data affecting an account or digital wallet, an individual digital token, etc.

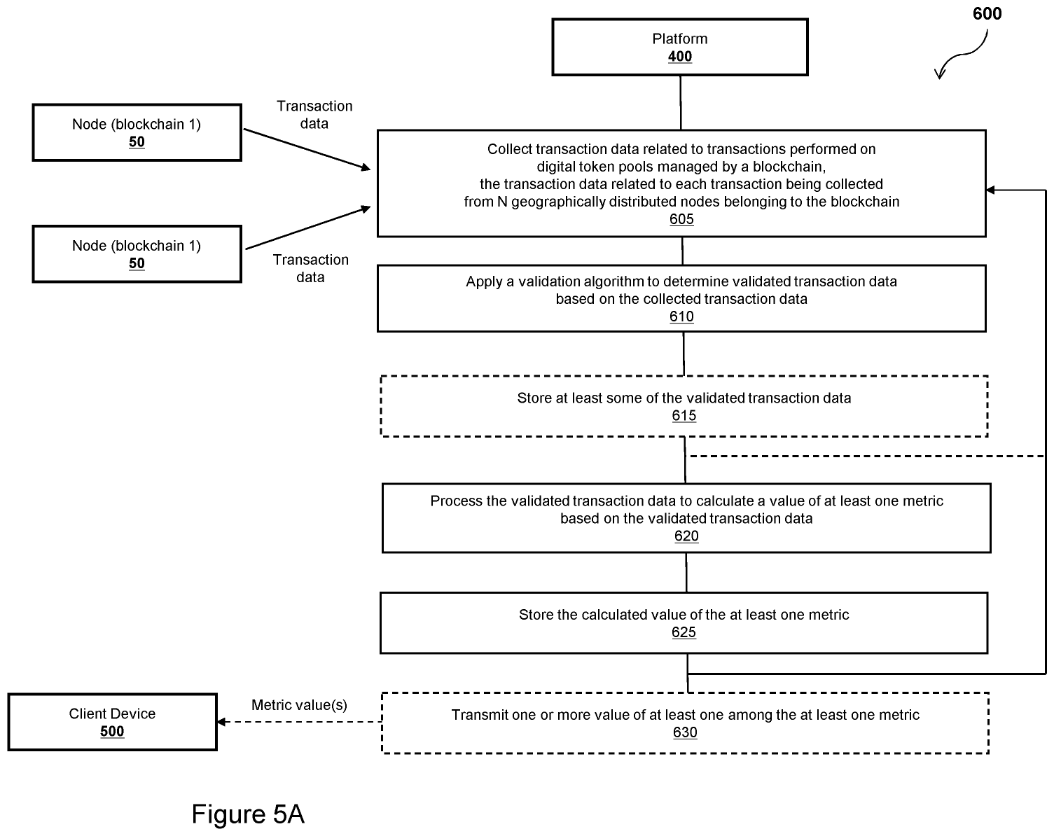

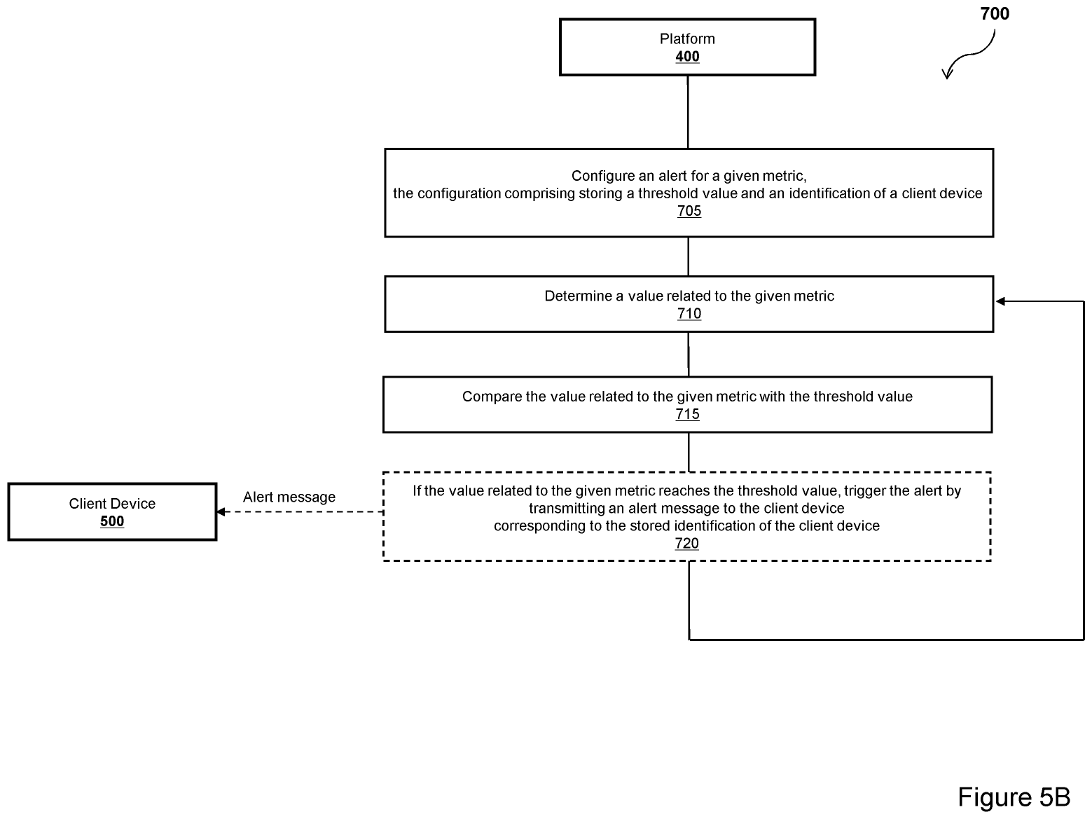

Referring now concurrently to FIGS. 4A-C and 5A, FIG. 5A represents a method 600 for calculating the values of the aforementioned metrics. At least some of the steps of the method 600 are implemented by the processing unit 410 of the platform 400. The method 600 includes steps for collecting and validating transaction data, and further steps for calculating the values of the metrics based on the transaction data.

Furthermore, a dedicated computer program has instructions for implementing at least some of the steps of the method 600. The instructions are comprised in a non-transitory computer-readable medium (e.g. the memory 420) of the platform 400. The instructions, when executed by the processing unit 410, provide for calculating the values of the aforementioned metrics. The instructions are deliverable to the platform 400 via an electronically-readable media such as a storage media (e.g. any internally or externally attached storage device connected via USB, Firewire, SATA, etc.), or via communication links (e.g. via a communication network through the communication interface 430).

The method 600 comprises the step 605 of collecting via the communication interface 430 transaction data related to transactions performed on digital token pools managed by a blockchain 10, the transaction data related to each transaction being collected from geographically distributed N nodes 50 belonging to the blockchain 10. N is an integer greater than one. As mentioned previously, the nodes 50 being geographically distributed means that the geographical location of the nodes 50 varies (e.g. different locations in a city, different cities, different provinces of a country, different countries, etc.) The transaction data are included in data blocks stored at the N nodes 50. Step 605 is executed by the processing unit 410.

As mentioned previously, examples of transactions for which transaction data are collected include (without limitations) a swap transaction, a sync transaction, a mint transaction, a burn transaction, etc. Another example of transaction is a meta transaction including a combination of unitary transactions. For instance, any combination of swap, sync, mint and burn transactions may be considered as a meta transaction for which transaction data are collected. Another example of a meta transaction is the combination of crediting (first unitary transaction) a first account and debiting (second unitary transaction) a second account, to represent a transfer from the second account to the first account.

The method 600 comprises the step 610 of applying a validation algorithm to determine validated transaction data based on the transaction data collected at step 605. Step 610 is executed by the processing unit 410. The previously described validation algorithm is implemented at step 610. As mentioned previously, for each transaction managed by the blockchain 10, candidate transaction data collected from the N nodes belonging to the blockchain 10 are processed by the validation algorithm to determine the validated transaction data.

The method 600 comprises the optional step 615 of storing at least some of the validated transaction data determined at step 610. Step 615 is executed by the processing unit 410. The storage is made in the memory 420 of the platform 400. Alternatively, the storage is made at a remote device (not represented in the Figures), by transmission via the communication interface 430 of the validated transaction data to be stored.

The method 600 comprises the step 620 of processing the validated transaction data to calculate a value of at least one metric based on the validated transaction data. Step 620 is executed by the processing unit 410. Examples of the calculation of the value of various metrics have been provided previously.

The method 600 comprises the step 625 of storing the value of the at least one metric calculated at step 625 in the memory 420. Step 625 is executed by the processing unit 410. Alternatively or complementarily, the at least one metric calculated at step 625 is transmitted (via the communication interface 430) to one or more remote devices (e.g. node(s) 50 of the blockchain 10) and stored at the one or more remote devices.

The method 600 comprises the optional step 630 of transmitting one or more values of at least one of the at least one metric calculated at step 620 to one or more client devices 500. Step 630 is executed by the processing unit 410. Examples of interactions between the platform 400 and the client devices 500 for requesting the transmission of the values of the metrics have been described previously.

Steps 605-625 (and optionally step 630) of the method 600 are repeated each time transaction data are collected from the nodes 50. Alternatively, steps 605-615 are repeated each time transaction data are collected from the nodes 50; but steps 620-625 (and optionally step 630) are performed only after a number of iterations of steps 605-615 have been performed. Furthermore, step 630 may be performed at any time, upon request of a client device 500.

The method 600 has been described with respect to transactions related to digital token pools managed by a single blockchain 10. However, the method 600 is applicable to any number of blockchains 10 managing digital token pools. At least steps 605 to 615 of the method 600 are performed concurrently for each of the blockchains 10. Furthermore, a metric calculated at step 620 may also be calculated based on validated transaction data originating from a plurality of blockchains 10.

Furthermore, in a particular implementation, the collection of transaction data at step 605 takes into consideration the entire history of transactions occurring on each blockchain for which the value of a metric is calculated at step 620. Each blockchain has a first data block referred to as the genesis block. Thus, the collection of transaction data takes into account all the data blocks from the genesis block up to a given data block. For example, the given data block is defined by a time T at which a transaction recorded by the given data block has occurred. The data blocks (if any) corresponding to transactions recorded after time T are not taken into consideration. The capability to take into consideration the entire history from the genesis block up to a certain point of time T is needed for ensuring the accuracy of at least some of the metrics calculated at step 620.

Additionally, well known blockchains such as Ethereum and BNB Chain are usually referred to as layer 1 blockchains. There exists a second type of blockchain referred to as layer 2 blockchain. FIG. 4C illustrates the platform 400 collecting transaction data from both a layer 1 blockchain (blockchain 1) and a layer 2 blockchain (blockchain 2). Examples of layer 2 blockchains include Arbitrum, Optimism, Metis, StarkEx, zkSync, etc. Layer 2 blockchains are optimized to improve transaction speed, scalability, security, etc. One use case for implementing layer 1 and layer 2 blockchains is the following. Details of the transactions are recorded on the layer 2 blockchain. At least one of a summary and a roll-up of the transactions is recorded on the layer 1 blockchain, with a pointer to the transaction details recorded on the layer 2 blockchain. FIG. 4C illustrates the layer 1 blockchain receiving data from the layer 2 blockchain to generate the summary/roll-up based on the detailed transaction data recorded at the layer 2 blockchain.

The aforementioned functionalities implemented by the platform 400 provide at least the following improvements over existing technologies: the calculation of metrics related to digital token pools which are not natively available through standard blockchain functionalities, the improvement of the accuracy and timeliness of the calculated metrics by using and verifying transaction data extracted from a plurality of nodes 50 (instead of using a single node 50 for collecting data related to a given transaction).

Furthermore, the aforementioned functionalities implemented by the platform 400 provide for saving an important quantity of processing power. In other implementations, since only the transactions (e.g. swaps, etc.) related to a digital token pool or a digital wallet are recorded by a blockchain, it is necessary in many cases to collect all the historical transaction data affecting a digital token pool or digital wallet, to be able to determine parameters such as the balance (in each type of digital token) stored in the digital token pool or the digital wallet. This collection of transaction data from the blockchain needs to be repeated every time a parameter such as the balance needs to be calculated, which is very intensive in terms of processing power. By contrast, the two steps mechanism implemented by the platform 400 allows to collect transaction data from the blockchain once and to store them at the platform, and to use the stored transaction data to generate metrics. Furthermore, the collected transaction data are stored in an effective format (e.g. in a database), which optimizes the querying of transaction data for calculating the metrics.

This capability for the platform 400 to save processing power in comparison to other implementations is a very important feature. The blockchain technology is viewed as an innovative and promising technology. However, it also has the drawback of having a negative impact on the climate due to its enormous consumption of processing power, which translates into enormous consumption of energy. The deployment of the platform 400 balances this impact in terms of energy consumption, by limiting the interactions with the blockchains for achieving the functionalities provided by the platform 400.

For example, using existing technology, it has been determined experimentally that extracting data directly from a blockchain and performing computations for one week worth of blockchain data for 12 data points for 630 digital token pools requires between 8 hours and 40 minutes and 9 hours and 40 minutes. By contrast, using the platform 400, it has been determined experimentally that data extraction, calculation, and writing data back to the blockchain for one week worth of blockchain data for 78 data points for 8668 digital token pools requires between 24 and 41 minutes. Thus, using existing technology took an average of 17 times longer to compute only 1.1% of the data computed by the platform 400 using the same data sets, computing equipment, and network connections.

### Alerts Generated by the Platform 400

The platform 400 provides the capability to generate alerts based on the occurrence of events. One type of event is the value of a metric calculated by the platform 400 reaching a pre-defined threshold. As is well known in the art, the value of a metric reaching a pre-defined threshold comprises the value of the metric being equal to a pre-defined value, the value of the metric being above a pre-defined value, the value of the metric being bellow a pre-defined value, the value of the metric being within an interval of two pre-defined values, the value of the metric being outside an interval of two pre-defined values etc.

As mentioned previously, the values of the metrics calculated by the platform 400 are updated on a regular basis, for example every time transaction data are collected from the nodes 50 of the blockchains 10. Each time the value of a metric for which an alert has been configured is updated, the value of the metric is compared to the pre-defined threshold and an alert is generated if the pre-defined threshold is reached.

Following is an exemplary use case for the usage of alerts. A client device 500 sends a request to the platform 400 for setting an alert. The request comprises an identification of a metric to monitor and a value of a threshold for the metric. The request is received via the communication interface 430 of the platform 400 and processed by the processing unit 410 to configure the alert. The processing of the request comprises storing in the memory 420 information comprising: the identification of the metric to monitor, the value of the threshold for the metric, and an identification of the client device 500 from which the request was received. Each time the processing unit 410 calculates an update of the value of the metric, the processing unit 410 determines if one or more alerts (thresholds) have been configured for this metric, based on the information stored in the memory 420. If an alert (threshold) is configured, the processing unit 410 determines if the value of the metric has reached the value of the threshold. If the determination is positive, the processing unit 410 triggers the alert by transmitting an alert message to the client device 500 associated to the threshold via the communication interface 430. The target device 500 is identified via the information (stored in the memory 420) previously provided for the identification of the client device 500 (upon reception of the corresponding request for setting the alert). The alert message comprises the identification of the metric, and optionally a current value of the metric. The result of the triggering of the alert is implementation dependent. For example, in addition to sending the alert message, the triggering of the alert results in performing additional action(s). Alternatively, the triggering of the alert does not result in the sending of the alert message, but results in performing other action(s).

Several alerts can be configured by different client devices 500 for the same metric. Each alert is managed independently by the platform 400 and has an associated threshold value. Thus, several different thresholds may be defined for the same metric. A given client device 500 may also define several alerts having respective different thresholds for the same metric.

In an exemplary implementation, a set of metrics for which an alert may be configured is determined for each client device 500 based on a subscription level. The subscription level determines which services offered by the platform 400 are available to a given client device 500. In particular, the rules for determining which metrics are available for configuring an alert based on the subscription level is implementation dependent, and is out of the scope of the present disclosure. Alternatively, by default, the platform 400 allows all (or a given subset) of the metrics to be available for configuring an alert by any of the client devices 500. Optionally, by configuration, only some of the metrics supported by the platform 400 are available for configuring an alert.

An alert may be defined on any of the previously mentioned metrics. For example, an alert is triggered if the value of a metric related to a number of transactions performed in relation to a given digital token pool over a time period is above a threshold value (or below a threshold value). In another example, an alert is triggered if the number of digital tokens of a given type present in a given digital token pool over a time period is above a threshold value (or below a threshold value). In still another example, an alert is triggered if the ratio of the number of digital tokens of a first type versus the number of digital tokens of a second type present in a given digital token pool over a time period is above a threshold value (or below a threshold value).

An alert may also be defined for a combination of metrics. In this case, an alert is triggered if for each of a plurality of metrics, the value of the metric reaches a corresponding threshold value. For instance, referring to the previous examples, an alert is triggered if the value of a metric related to a number of transactions performed in relation to a given digital token pool over a time period is above a first threshold value (or below the first threshold value) and if the number of digital tokens of a given type present in the given digital token pool over the time period is above a second threshold value (or below the second threshold value).

In a complementary implementation, an alert may also be defined for a transaction parameter of an individual transaction collected in the transaction data. For example, in a swap transaction with respect to a given digital token pool, a threshold is defined for the number of digital tokens of a given type added and/or removed from the given digital token pool by the swap transaction. The processing unit 410 analyses the transaction data collected from the nodes 50, more specially the transaction data related to any swap operation with respect to the given digital token pool. If for a given swap transaction, the number of digital tokens added to the given digital token pool is above (or below) a first threshold value, an alert is raised (and sent to the client device 500 which requested the alert to be configured). Alternatively or complementarily, if for a given swap transaction, the number of digital tokens removed from the given digital token pool is above (or below) a second threshold value, an alert is raised (and sent to the client device 500 which requested the alert to be configured).

Another type of event for which an alert can be defined is a variation of the value of a metric over a given time period (e.g. an hour, a day, a week, a month, etc.) reaching a predefined threshold. In an exemplary implementation, the value of the metric at the beginning of the given time period defines a reference value. If during the given time period, the variation of the instant value (the value at a time t during the given time period) of the metric with respect to the reference value reaches the pre-defined threshold, then the alert is triggered. In another exemplary implementation, the variation is defined as a difference between the maximum value and the minimum value reached by the metric during the given time period.

The previously described examples of alerts are adapted as follows. An alert is triggered if a variation in the value of a metric related to a number of transactions performed in relation to a given digital token pool over a time period reaches a threshold value. An alert is triggered if a variation in the number of digital tokens of a given type present in a given digital token pool over a time period reaches a threshold value. An alert is triggered if a variation in the ratio of the number of digital tokens of a first type versus the number of digital tokens of a second type present in a given digital token pool over a time period reaches a threshold value.

Expanding on the previous examples, an alert may also be raised if and when a specific account or digital wallet creates a transaction that affects a digital token pool.

A person skilled in the art will readily understand that alerts can be defined for other types of transaction parameters of an individual transaction collected in the transaction data. The configuration, management, and processing of alerts defined for a transaction parameter of an individual transaction collected in the transaction data is similar to the previously description of the configuration, management and processing of alerts defined for metrics.

Although the implementation of alerts has been described in relation to a digital token pool, the previously described functionalities also apply to the implementation of alerts related to accounts or digital wallets, individual digital tokens, etc.

Monitoring transactions occurring on a blockchain only provides information related to mint, swap, burn and sync transactions. Since the previously described metrics calculated by the platform 400 are not intrinsically supported by blockchains, the platform 400 provides new monitoring and alert capabilities based on the calculated metrics (which are not intrinsically supported by blockchains).

Expanding to two or more blockchains, an alert may be raised if one or more metrics on blockchain 1 are not equal to the one or more metrics on blockchain 2 or blockchain 3, etc. The same principle applies when a blockchain is used as a layer 2, an alert may be raised if one or more metrics on the layer 1 blockchain are not equal to one or more metrics on the layer 2 blockchain.

Referring now concurrently to FIGS. 4A-C and 5B, FIG. 5B represents a method 700 for generating an alert related to a metric. At least some of the steps of the method 700 are implemented by the processing unit 410 of the platform 400.

Furthermore, a dedicated computer program has instructions for implementing at least some of the steps of the method 700. The instructions are comprised in a non-transitory computer-readable medium (e.g. the memory 420) of the platform 400. The instructions, when executed by the processing unit 410, provide for generating an alert related to a metric. The instructions are deliverable to the platform 400 via an electronically-readable media such as a storage media (e.g. CD-ROM, or any internally or externally attached storage device connected via USB, Firewire, SATA, etc.), or via communication links (e.g. via a communication network through the communication interface 430).

The method 700 comprises the step 705 of configuring an alert for a given metric. Step 705 is executed by the processing unit 410. The configuration comprises storing in the memory 420 a threshold value and an identification of a client device 500.

The method 700 comprises the step 710 of determining a value related to the given metric. Step 710 is executed by the processing unit 410. As mentioned previously, examples of the value related to the given metric comprise the value of the given metric (calculated at step 620 of the method 600 illustrated in FIG. 5A), the measure of a variation of the value of the given metric over a given period of time (based on the calculations performed at step 620 of the method 600 illustrated in FIG. 5A), etc.

The method 700 comprises the step 715 of comparing the value related to the given metric calculated at step 710 with the threshold value. Step 715 is executed by the processing unit 410.

The method 700 comprises the optional step 720 of triggering the alert. The triggering of the alert comprises transmitting via the communication interface 430 an alert message to the client device 500 corresponding to the identification of the client device stored in the memory 420. Step 720 is executed by the processing unit 410 only if the value related to the given metric reaches the threshold value.

The method 700 repeats steps 710 and 715 (and performs step 720 each time the threshold value is reached by the metric).

Step 710 corresponds to step 620 of the method 600 represented in FIG. 5A.

As mentioned previously, an alert may be configured with a plurality of metrics and a corresponding plurality thresholds. The alert is triggered if the respective values related to the plurality of metrics simultaneously reach their respective corresponding thresholds.

Alerts may also be defined for other data collected and/or generated by the platform 400. For example, the platform 400 determines a sentiment in relation to an asset monitored by the platform 400. More specifically, one or more values presentative of the sentiment are determined by the platform 400. If one of the values representative of the sentiment reaches a corresponding pre-defined threshold, an alert is triggered. For example, the sentiment is represented by a percentage of positive textual content (considered positive in sentiment), a percentage of neutral textual content (considered neutral in sentiment) and a percentage of negative textual content (considered negative in sentiment), respectively determined based on data collected by the platform 400. The (positive, neutral and negative) textual content is made up of one or more words, including group(s) of words being in proximity to one another. A threshold value can be defined with respect to at least one of the percentages of positive, neutral and negative textual content. In another example, the platform 400 determines a risk in relation to an asset monitored by the platform 400. More specifically, a value presentative of the risk is determined by the platform 400. If the value representative of the risk reaches a pre-defined threshold, an alert is triggered.

### Predictions Using a Neural Network

The neural network technology relies on the collection of a large quantity of data during a training phase, which are used for training a neural network. The result of the training phase is a predictive model generated by the neural network. Then, during an operational phase, the neural network uses the predictive model to generate predicted outputs based on inputs.

Although the rest of the disclosure is based on the usage of a neural network for illustration purposes only, a person skilled in the art would readily understand that other machine learning technologies may be used in place of a neural network, such as generative pre-trained transformers, a decision tree, a support vector machine, a regression analysis, a Bayesian network, a causality analysis, etc.

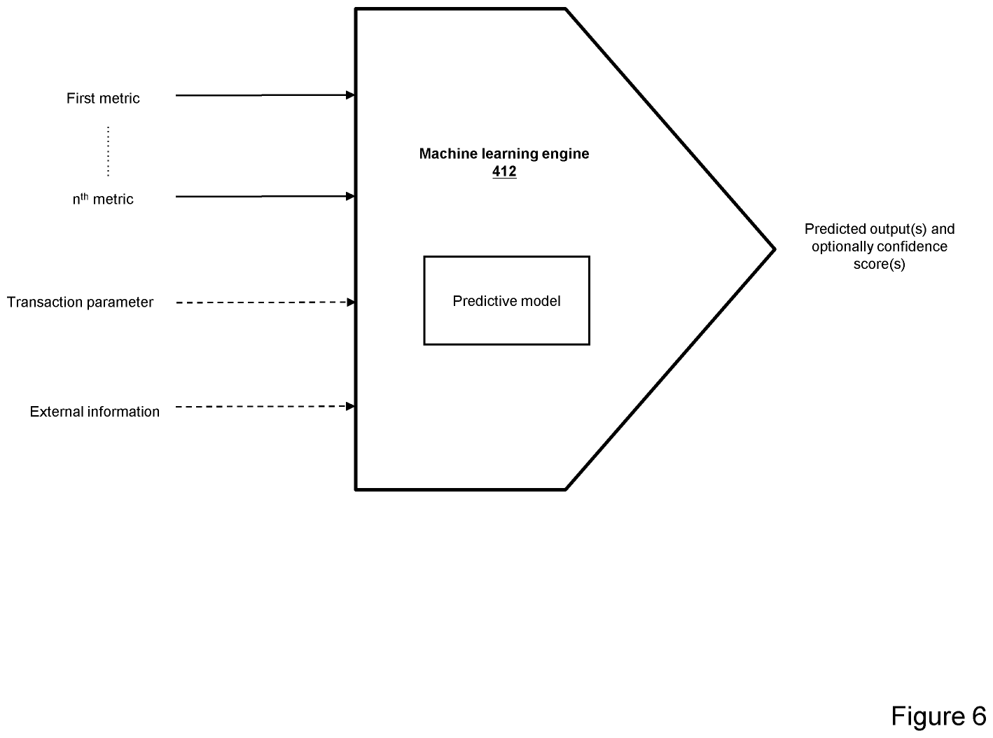

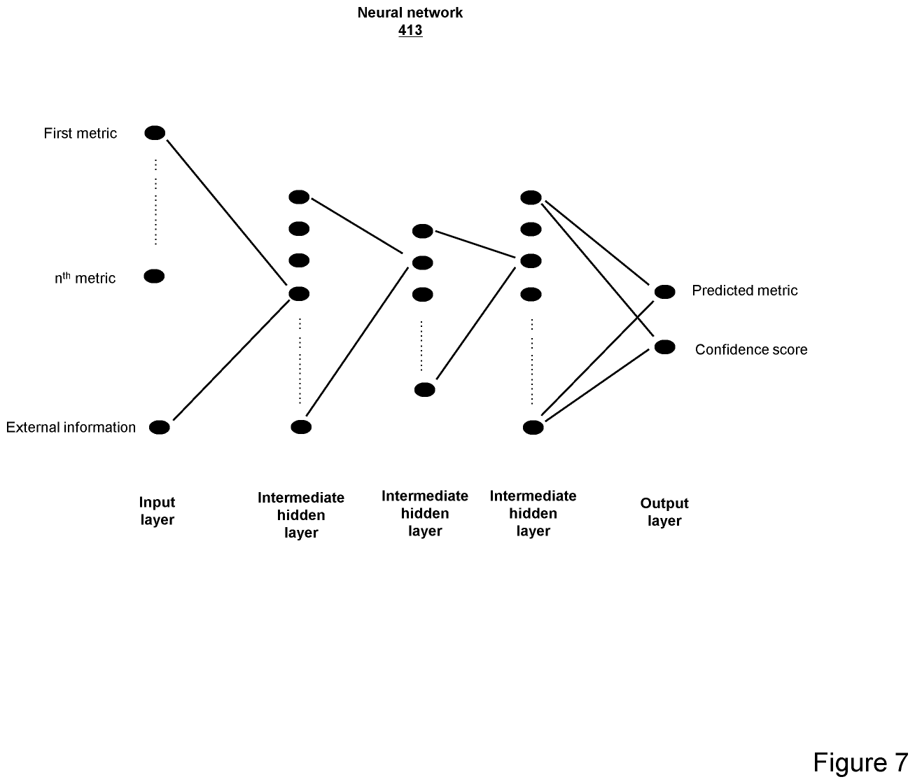

Referring now concurrently to FIGS. 4A-C, 6 and 7, FIG. 6 represents a machine learning engine 412 (e.g. a neural network) executed by the processing unit 410 of the platform 400 with its inputs and its output(s). FIG. 7 provides a detailed representation of a neural network 413 implemented by the machine learning engine 412.

FIG. 6 illustrates the types of inputs received by the machine learning engine 412 to generate predicted output(s). Any type of metric, calculated by the platform 400 as described previously (according to the method 600 illustrated in FIG. 5A), can be used as input. Any type of transaction parameter, collected by the platform 400 as described previously (according to the method 600 illustrated in FIG. 5A), can be used as input. Additional external information collected by the platform 400 can also be used as input.

FIG. 6 is for illustration purposes only. FIG. 6 illustrates a configuration where n metrics are used as inputs (n being an integer greater than 1 for illustration purposes only). FIG. 6 further illustrates a configuration where optionally, one transaction parameter and/or one external information is used as inputs (in addition to the n metrics). More generally, the following combination of inputs are considered in the present disclosure: a plurality of metrics only, at least one metric and at least one transaction parameter, at least one metric and at least one external information, at least one metric and at least one transaction parameter and at least one external information, a plurality of transaction parameters only, at least one transaction parameter and at least one external information.

With respect to the generated predicted output(s), any type of metric, calculated by the platform 400 as described previously, can be generated as a predicted output. Any type of transaction parameter, collected by the platform 400 as described previously, can be generated as a predicted output. Alternatively or complementarily, a new type of metric which is not calculated by the platform 400 can be generated as a predicted output. Optionally, one or more confidence scores related to the predicted output(s) are also generated as output. For example, a single confidence score applying to all the predicted output(s) is generated. Alternatively, a plurality of confidence scores is generated, each confidence score applying to one or more of the plurality of predicted outputs.

One example of predicted output is a predicted value of the previously mentioned metric consisting of the volume for a given digital token pool (managed by a blockchain) over a time period. The volume may take several forms, such as the number of digital tokens of a given type exchanged via the given digital token pool over the time period, a monetary value of all the swaps performed on the given digital token pool over the time period, etc. A combination of at least some of the following inputs can be used for performing volume predictions: number of transactions performed on the given digital token pool over a reference time period, number of swap transactions of a given type of digital token performed on the given digital token pool over a reference time period, number of digital tokens of a given type present in the given digital token pool over a reference time period, etc. The predicted value of the volume over a time period corresponds to a time period in the future (for which no data are available). The reference time period for the inputs corresponds to a time period in the past, for which reference data are available (have been calculated/collected).

One or more parameters related to the volume for the digital token pool over the reference time period can also be used as an input: total volume since creation of the digital token pool, average volume for the digital token pool over the reference period, highest recorded volume for the digital token pool over the reference time period, etc.

Other types of inputs related to the digital token pool may also be used for predicting the future volume for a digital token pool: yield from the fees generated by the digital token pool over the reference time period, a total value locked in the digital token pool over the reference time period, a value (e.g. average price, maximum price, etc.) of a type of digital token managed by the digital token pool over the reference of time, etc.

Specific features of the digital token pool may also be used as inputs: features of the tokens managed by the digital token pool, underlying asset, creation date of the digital token pool (number of days of existence of the digital token pool), type of blockchain used for the digital token pool, etc.

The value (e.g. average price, maximum price, etc.) of assets not managed by the digital token pool may also be used as input for predicting the future volume for a digital token pool: value of a currency over the reference time period, value of a commodity over the reference time period, etc.

Furthermore, the prediction of the future volume for a digital token pool may apply to a specific hour of the day, to a specific day of the week, etc. (e.g. predicted hourly volume at 10 am and predicted hourly volume at 3 pm, predicted hourly volume on Mondays and predicted hourly volume on Fridays, etc.).

Additionally, a measure of market sentiment can also be used as input, to integrate the influence of social and market factors reported in news and social media, Natural language processing is used for converting the social and market factors into actionable input(s), which can be used for the prediction of the volume for the digital token pool.

Training predictive models directly using data stored on blockchain(s) would significantly increase the training time, due to the inherent latency of retrieving large quantities of data from blockchain(s). Thus, the usage of the aforementioned metrics for prediction purposes provides advantages in terms of efficiency (time required for performing the training, processing power required for performing the training, etc.), in contrast to directly using data stored on blockchain(s).

Optionally, a normalization process is applied to at least some of the inputs before they are used as normalized input(s) of the neural network 413.

The neural network 413 illustrated in FIG. 7 includes an input layer with neurons for receiving inputs consisting of n metrics and one external information. The neural network includes an output layer with two neurons for outputting two outputs consisting of a predicted metric (e.g. the previously mentioned volume predictions) and a confidence score applying to the predicted metric. The output of a confidence score is optional: the outputs of the neural network 413 may only include the predicted metric. The number of neurons of the input layer, the inputs, the number of neurons of the output layer and the outputs represented in FIG. 7 are for illustration purposes only, and can be adapted to support more or less inputs, other types of inputs, more or less outputs, and other types of outputs.

The neural network 413 includes three intermediate hidden layers between the input layer and the output layer. All the layers are fully connected. A layer L being fully connected means that each neuron of layer L receives inputs from every neurons of layer L−1, and applies respective weights to the received inputs. By default, the output layer is fully connected to the last hidden layer. The number of intermediate hidden layers is an integer greater or equal than 1 (FIG. 7 represents three intermediate hidden layers for illustration purposes only). The number of neurons in each intermediate hidden layer may vary. During the training phase of the neural network 413, the number of intermediate hidden layers and the number of neurons for each intermediate hidden layer are selected, and may be adapted experimentally. The generation of the outputs based on the inputs using weights allocated to the neurons of the neural network 413 is well known in the art. The architecture of the neural network, where each neuron of a layer (except for the first layer) is connected to all the neurons of the previous layer is also well known in the art.

The predicted metric generated by the neural network 413 may be of the same type as one of the n metrics used as inputs of the neural network 413, or may be of a different type.

In a particular implementation, instead of using a single value for a given type of input of the neural network 413, a series of N consecutive values is used as inputs. For example, a series of N values of the first metric is used as inputs of the neural network 413. The neural network 413 comprises N neurons in the input layer for receiving the N consecutive values of the first metric (instead of a single neuron, as illustrated in FIG. 7, for receiving the first metric). More than one type of input of the neural network 413 may use a series of values for the inputs instead of a single value (e.g. a series of values of the first metric and a series of values of a second metric are used as inputs of the neural network 413). In an exemplary implementation, the series of N values of a metric used as input of the neural network 413 is a timeseries of the metric (e.g. N consecutive values of the metric every hour, every day, etc.).

The neural network 413 may also use convolution layer(s) and optionally pooling layer(s) following the convolution layer(s). For example, if an input consists of a series of N values, a one-dimension convolution is applied to the series of N values before further processing by the neural network 413. In another example, if several inputs consist of a series of N values, a two-dimensions convolution is applied to the several series of N values before further processing by the neural network 413.

Following is a description of the training phase, which results in the generation of the predictive model of the neural network 413. During the training phase, a neural network training engine is trained with a plurality of inputs and a corresponding plurality of outputs. The types of inputs and outputs used during the training phase are the same as the types of inputs and outputs used during the operational phase.

The neural network training engine is executed by a processing unit of a dedicated training server (not represented in the Figures for simplifications purposes). Once the training is completed, the predictive model is transmitted to the platform 400. The predictive model is received via the communication interface 430 and stored in the memory 420. During the operational phase, the predictive model stored in the memory 420 is used by the machine learning engine 412 executed by the processing unit 410. Alternatively, the neural network training engine is executed by the processing unit 410 of the platform 400 and the training phase is performed directly by the platform 400.

As is well known in the art of neural networks, during the training phase, the neural network 413 implemented by the machine learning engine 412 adjusts its weights. Furthermore, during the training phase, the number of layers of the neural network 413 and the number of nodes per layer can be adjusted to improve the accuracy of the model. At the end of the training phase, the predictive model generated by the neural network training engine includes the number of layers, the number of neurons per layer, and the weights. In the case where normalization of some of the inputs is needed, a weighted sampling scheme can be used to generate a training set.

Various techniques well known in the art of neural networks are used for performing (and improving) the generation of the predictive model, such as forward and backward propagation, usage of bias in addition to the weights (bias and weights are generally collectively referred to as weights in the neural network terminology), reinforcement learning, etc.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A platform comprising:
a communication interface;
memory; and
a processing unit comprising one or more processors configured to:
collect via the communication interface transaction data related to transactions performed on digital token pools managed by a blockchain, the transaction data related to each transaction being collected from N geographically distributed nodes belonging to the blockchain, N being an integer greater than one, the transaction data being included in data blocks stored at the N nodes;
apply a validation algorithm to determine validated transaction data based on the collected transaction data, the validation algorithm comprising comparing for each transaction the transaction data collected from the N nodes and determining the validated transaction data for the transaction based at least on a result of the comparison;
process the validated transaction data to calculate a value of at least one metric based on the validated transaction data; and
store the calculated value of the at least one metric in the memory or transmit the calculated value of the at least one metric via the communication interface to at least one remote device for remote storage.

2. The platform of claim 1, wherein the transaction data are related to transactions performed on digital token pools managed by a plurality of blockchains, the transaction data being collected for each blockchain from the nodes belonging to the blockchain.

3. The platform of claim 2, wherein the plurality of blockchains comprises a layer 1 blockchain and a layer 2 blockchain, the transaction data collected from the layer 1 blockchain comprising at least one of a summary and a roll-up of transaction data recorded on the layer 2 blockchain.

4. The platform of claim 1, wherein the N nodes vary according to at least one of the following patterns: the number N of nodes varies over time and at least one of the N nodes varies over time.

5. The platform of claim 1, wherein the data blocks from which transaction data are collected include all the data blocks from a genesis block up to a given data block.

6. The platform of claim 1, wherein the transactions comprise at least one of the following: a swap transaction, a sync transaction, a mint transaction, a burn transaction, and a combination of unitary transactions.

7. The platform of claim 1, wherein at least some of the validated transaction data are stored in the memory before being processed.

8. The platform of claim 1, wherein the processing unit is further configured to transmit to one or more client devices via the communication interface one or more values of at least one among the at least one metric.

9. The platform of claim 1, wherein the processing unit is further configured to:
configure an alert for a given metric, the configuration comprising storing in the memory a threshold value and an identification of a client device;
determine a value related to the given metric;
compare the value related to the given metric with the threshold value; and
if the value related to the given metric reaches the threshold value, trigger the alert, the triggering of the alert comprising transmitting via the communication interface an alert message to the client device corresponding to the identification of the client device stored in the memory.

10. The platform of claim 9, wherein the alert is configured with a plurality of metrics and a corresponding plurality of thresholds, the alert being triggered if values associated to the plurality of metrics simultaneously reach their respective corresponding thresholds.

11. The platform of claim 1, wherein the processing unit is further configured to execute a machine learning engine, the machine learning engine using a predictive model stored in the memory for inferring one or more outputs based on inputs, the one or more outputs comprising a predicted volume for a digital token pool, the inputs comprising the value of the at least one metric.

12. A method for collecting and analyzing transactions performed on digital token pools managed by a blockchain, the method comprising:
collecting by a processing unit of a platform via a communication interface of the platform transaction data related to transactions performed on digital token pools managed by a blockchain, the transaction data related to each transaction being collected from N geographically distributed nodes belonging to the blockchain, N being an integer greater than one, the transaction data being included in data blocks stored at the N nodes;
applying by the processing unit of the platform a validation algorithm to determine validated transaction data based on the collected transaction data, the validation algorithm comprising comparing for each transaction the transaction data collected from the N nodes and determining the validated transaction data for the transaction based at least on a result of the comparison;
processing by the processing unit of the platform the validated transaction data to calculate a value of at least one metric based on the validated transaction data; and
storing by the processing unit of the platform the calculated value of the at least one metric in a memory of the platform or transmitting the calculated value of the at least one metric via the communication interface to at least one remote device for remote storage.

13. The method of claim 12, wherein the transaction data are related to transactions performed on digital token pools managed by a plurality of blockchains, the transaction data being collected for each blockchain from the nodes belonging to the blockchain.

14. The method of claim 13, wherein the plurality of blockchains comprises a layer 1 blockchain and a layer 2 blockchain, the transaction data collected from the layer 1 blockchain comprising at least one of a summary and a roll-up of transaction data recorded on the layer 2 blockchain.

15. The method of claim 12, wherein the data blocks from which transaction data are collected include all the data blocks from a genesis block up to a given data block.

16. The method of claim 12, wherein the transactions comprise at least one of the following: a swap transaction, a sync transaction, a mint transaction, a burn transaction, and a combination of unitary transactions.

17. The method of claim 12, further comprising:
configuring by the processing unit of the platform an alert for a given metric, the configuration comprising storing in the memory of the platform a threshold value and an identification of a client device;
determining by the processing unit of the platform a value related to the given metric;
comparing by the processing unit of the platform the value related to the given metric with the threshold value; and
if the value related to the given metric reaches the threshold value, triggering by the processing unit of the platform the alert, the triggering of the alert comprising transmitting via the communication interface of the platform an alert message to the client device corresponding to the identification of the client device stored in the memory.

18. The method of claim 17, wherein the alert is configured with a plurality of metrics and a corresponding plurality of thresholds, the alert being triggered if values associated to the plurality of metrics simultaneously reach their respective corresponding thresholds.

19. The method of claim 12, wherein the processing unit of the platform is further configured to execute a machine learning engine, the machine learning engine using a predictive model stored in the memory of the platform for inferring one or more outputs based on inputs, the one or more outputs comprising a predicted volume for a digital token pool, the inputs comprising the value of the at least one metric.

20. A non-transitory computer-readable medium comprising instructions executable by a processing unit of a platform, the execution of the instructions by the processing unit of the platform providing for collecting and analyzing transactions performed on digital token pools managed by a blockchain by:
collecting by a processing unit of the platform via a communication interface of the platform transaction data related to transactions performed on digital token pools managed by a blockchain, the transaction data related to each transaction being collected from N geographically distributed nodes belonging to the blockchain, N being an integer greater than one, the transaction data being included in data blocks stored at the N nodes;
applying by the processing unit of the platform a validation algorithm to determine validated transaction data based on the collected transaction data, the validation algorithm comprising comparing for each transaction the transaction data collected from the N nodes and determining the validated transaction data for the transaction based at least on a result of the comparison;
processing by the processing unit of the platform the validated transaction data to calculate a value of at least one metric based on the validated transaction data; and
storing by the processing unit of the platform the calculated value of the at least one metric in a memory of the platform or transmitting the calculated value of the at least one metric via the communication interface to at least one remote device for remote storage.
